(19) United States
(12) Patent Application Publication
(10) Pub. No.: US 2025/0089086 A1
(43) Pub. Date: Mar. 13, 2025

(54) ENHANCED R-TWT FOR ROAMING NON-AP MLD

(71) Applicants: SONY GROUP CORPORATION, Tokyo (JP); SONY CORPORATION OF AMERICA, New York, NY (US)

(72) Inventor: Qing Xia, San Jose, CA (US)

(73) Assignees: SONY GROUP CORPORATION, Tokyo (JP); SONY CORPORATION OF AMERICA, New York, NY (US)

(21) Appl. No.: 18/813,752

(22) Filed: Aug. 23, 2024

Related U.S. Application Data
(60) Provisional application No. 63/581,743, filed on Sep. 11, 2023.

(51) Int. Cl. H04W 74/0816; H04L 5/00; H04W 74/04; H04W 84/12

(52) U.S. Cl. CPC H04W 74/04; H04L 5/0053; H04W 84/12

(57) ABSTRACT

A wireless protocol for providing smooth roaming when a non-Access Point (non-AP) Multi-Link Device (MLD) roams between Basic Service Sets (BSSs). One or more links of a roaming non-AP MLD can be in the process of communicating latency sensitive traffic during a R-TWT SP of a first BSS while roaming to a target BSS. Negotiation is made with the AP MLD of the target BSS so that upon completion of roaming to the target BSS, one or more links of the roaming non-AP MLD are allowed to use a predetermined/enhanced R-TWT SP of the target BSS without further negotiation.

### CROSS-REFERENCE TO RELATED APPLICATIONS

This application claims priority to, and the benefit of, U.S. provisional patent application Ser. No. 63/581,743 filed on Sep. 11, 2023, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to roaming operations of a non-AP Multiple Link Device (MLD), and more particularly to enhanced Restricted Target-Wake-Time (R-TWT) for Roaming non-AP MLDs.

### 2. Background Discussion

The new generation Wi-Fi (Wi-Fi8) is targeted toward achieving higher reliability for wireless communication while maintaining low latency performance. R-TWT was designed in Wi-Fi7 to prioritize low latency traffic within a protected service period for R-TWT member STAs. However, mechanisms are not available for performing R-TWT when a roaming STA is transiting from one BSS to another BSS.

Accordingly, a need exists for an enhanced R-TWT protocol to fully accommodate roaming. The present disclosure fulfills that need and provides additional benefits over existing systems.

### BRIEF SUMMARY

The present disclosure is a apparatus/method/protocol for providing smooth roaming when a non-Access Point (non-AP) station (STA) roams between Basic Service Sets (BSSs). The disclosure provides a number of beneficial elements and interoperations, briefly discussed below.

Having a roaming non-AP MLD which is in the process of transmitting/receiving latency sensitive traffic during a R-TWT SP while roaming to a target BSS to use a predetermined/enhanced R-TWT SP which is accepted by the target AP MLD without further negotiation for the R-TWT SP after roaming. The present disclosure allows the roaming non-AP MLD to set up the enhanced R-TWT SP roaming at either the AP MLD level or at the link level of the MLD. In case of a scheduled enhanced R-TWT SP for roaming at the AP MLD level, either a universal enhanced R-TWT SP, or a non-universal enhanced R-TWT SP with multiple R-TWT SPs is performed, corresponding to different AP MLDs of the roaming AP MLD can be scheduled. In the case of a scheduled enhanced R-TWT SP at the AP MLD level, the non-AP MLD can negotiate an enhanced R-TWT with the target AP MLD, and relaying information of its associated AP MLD and the Roaming AP MLD. Toward achieving enhanced R-TWT SP setup, a new TID-to-Global-Link Mapping configuration is provided which indicates the links, identified by global link IDs, on which frames belonging to each Traffic Identifier (TID) can be exchanged. The disclosure also describes new enhanced R-TWT termination rules when the roaming non-AP MLD is moving close to, or across the edge of the range provided by the original associated AP MLD. In addition, resume/restart rules are described for a new enhanced R-TWT through which communications are directed when the roaming non-AP MLD finishes transition to the BSS of the roaming target AP MLD.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a block diagram of Multi-Link Device (MLD) hardware according to at least one embodiment of the present disclosure.

FIG. 3A through FIG. 3E is a block diagram of a roaming AP MLD architecture according to at least one embodiment of the present disclosure.

FIG. 4 and FIG. 5 are topology examples utilized as an aid for discussing the communication protocols according to at least one embodiment of the present disclosure.

FIG. 6 is a frequency chart of an example in which UORA is used after non-AP MLD roaming according to at least one embodiment of the present disclosure.

FIG. 7 is a communication diagram of negotiating for TID-to-Global-Link Mapping (TTGLM) according to at least one embodiment of the present disclosure.

FIG. 8A and FIG. 8B is a communication diagram of negotiating an enhanced R-TWT between a roaming non-AP MLD and its associated AP MLD, through a roaming AP MLD, on behalf of the target AP MLD, according to at least one embodiment of the present disclosure.

FIG. 9 is a flow diagram for a roaming non-AP MLD for negotiating an enhanced R-TWT schedule acceptable to the roaming target AP MLD, according to at least one embodiment of the present disclosure.

FIG. 10 is a data field diagram of a TID-to-Global-Link Mapping element format, according to at least one embodiment of the present disclosure.

FIG. 11 is a data field diagram of subfields within the TID-to-Global-Link Control field shown in FIG. 10, according to at least one embodiment of the present disclosure.

FIG. 12 is a data field diagram of an enhanced Broadcast TWT Parameter Set field format, according to at least one embodiment of the present disclosure.

FIG. 13 is a data field diagram of the Request Type field format in Broadcast TWT Parameter Set field of FIG. 12, according to at least one embodiment of the present disclosure.

FIG. 14A and FIG. 14B is a communications diagram of MLD level terminating and starting an R-TWT SP for a roaming non-AP MLD with frequency preemption before roaming, according to at least one embodiment of the present disclosure.

FIG. 15A and FIG. 15B is a communications diagram of MLD level terminating and starting an R-TWT SP for a roaming non-AP MLD before and after roaming with time preemption prior to roaming, according to at least one embodiment of the present disclosure.

FIG. 16A and FIG. 16B is a communications diagram of MLD level terminating and starting an R-TWT SP for a roaming non-AP MLD before and after roaming with frequency preemption before roaming, according to at least one embodiment of the present disclosure.

FIG. 17A and FIG. 17B is a communications diagram of MLD level terminating and starting of an R-TWT SP for a roaming non-AP MLD before and after roaming with frequency preemption before roaming, according to at least one embodiment of the present disclosure.

FIG. 18A and FIG. 18B is a communications diagram of link level terminating and starting an R-TWT SP for a roaming non-AP MLD before and after roaming with time preemption before roaming, according to at least one embodiment of the present disclosure.

FIG. 19A and FIG. 19B is a communications diagram of link level termination and starting an R-TWT SP of roaming non-AP MLD before and after roaming with frequency preemption before roaming, according to at least one embodiment of the present disclosure.

### DETAILED DESCRIPTION

### 1. Introduction

The new generation Wi-Fi (Wi-Fi8) is targeting to achieve higher reliability for wireless communication while retaining latency performance improvements. A smooth roaming approach for stations (STAs) roaming with latency sensitive traffic, aligns with the target of Wi-Fi8. Restricted Target Wake Time (R-TWT) was designed in Wi-Fi7 to prioritize low latency traffic within a protected service period for R-TWT member STAs; wherein issues can arise on how to process R-TWT Service Periods (SP) when a roaming STA transits from one Basic Service Set (BSS) to another BSS.

### 2. Current Version of IEEE802.11ax

### 2.1. UL OFDMA-Based Random Access (UORA)

Upload Orthogonal frequency division multiple Random Access (UORA) is a feature designed in IEEE802.11ax for a non-Access Point (non-AP) High Efficiency (HE) STA to gain channel access using a Receiver Address (RA)-Resource Unit (RU) that is assigned by the associated HE AP.

An HE AP may transmit a Basic Trigger frame (BT frame), Bandwidth Query Report Poll (BQRP) Trigger frame or Buffer Status Report Poll (BSRP) Trigger frame that contains one or more RUs for random access.

The AP shall indicate the range of the Orthogonal Frequency Division Multiple Access (OFDMA) contention window (OCW) for non-AP STAs to initiate random access following the reception of the Trigger frame sent by the AP.

The OFDMA Contention Window (OCW), is an integer in a range from OCWmin to OCWmax, which is set in the UORA Parameter Set element, which is contained in Management frames, for example Beacon frames, Probe Response frames or (Re) Association Response frames.

Each time a non-AP HE STA associates with a different AP, and prior to its initial attempt of RA-RU transmission toward it, the non-AP HE STA shall set the value of OCW to the OCWmin value and shall initialize its OFDMA random access backoff OFDMA Backoff (OBO) counter in a range from zero to OCW. The (OBO) counter is used by the non-AP HE STA to count down before accessing the RA-RUs.

Upon reception of a Trigger frame containing at least one eligible RA-RU, the HE STA that has a pending frame for the AP can randomly select one of the eligible RA-RUs for transmission if the OBO counter does not exceed the number of eligible RA-RUs and it shall set its OBO counter to zero. Otherwise, the HE STA decrements its OBO counter by the number of eligible RA-RUs in the Trigger frame. It should be noted that the 802.11BE currently doesn't support UORA in R-TWT.

### 2.2. Restricted-Target Wake Time (R-TWT)

Target wake time (TWT) allows an AP to manage activity in the BSS to minimize contention between STAs and to reduce the duration of time spent awake by a STA in power management mode.

R-TWT is developed based on (Broadcast)-TWT (B-TWT) and enables the STAs in a BSS to use enhanced medium access protection for delivery of latency sensitive traffic.

An R-TWT scheduling AP is an Extra High Throughput (EHT) AP that supports R-TWT. An R-TWT scheduled STA is a non-AP EHT STA that supports R-TWT and establishes R-TWT membership for one or more R-TWT schedules with its associated EHT AP. An R-TWT supporting STA is a non-AP EHT STA that supports R-TWT, that may or may not established R-TWT membership with its associated EHT AP. An R-TWT membership is negotiated between an R-TWT scheduled STA and an R-TWT scheduling AP for utilizing a specific R-TWT SP (Service Period), which is identified by an R-TWT identifier (ID).

During an R-TWT SP, the R-TWT scheduling AP and the R-TWT scheduled STAs prioritize their transmission of Quality-of-Service (QOS) Data frames that are latency sensitive traffic. An R-TWT scheduling AP may schedule a quiet interval that commences at the same time as the corresponding R-TWT SP. Non-AP non-EHT (legacy) STAs follow the quiet rule and shall not transmit Physical-layer Protocol Data Unit (PPDUs) to the AP during the quiet interval. Non-AP EHT (11be) STAs may behave as if overlapping quiet intervals do not exist. An R-TWT scheduled STA can teardown single or all R-TWT membership(s) of the existing R-TWT SPs.

General channel access rules for R-TWT SPs apply to both trigger-enabled and non-trigger-enabled SPs. The R-TWT supporting STA as a Transmit Opportunity (TXOP) holder shall ensure that the TXOP ends before the start time of any active R-TWT SPs that are advertised by its associated AP. The R-TWT scheduling AP as a TXOP holder shall ensure the TXOP ends before the start time of any active R-TWT SP advertised by itself, unless the remaining portion of the TXOP falls within the R-TWT SP is being used for the delivery of Downlink (DL) frames of R-TWT DL Transmit IDs (TIDs) or to solicit the Uplink frames of R-TWT UL TID(s). The R-TWT supporting STA checks if there is sufficient time for the frame exchange to be completed prior to the start of the R-TWT SP, and if there is not enough time, then the STA shall defer transmission by selecting a random backoff count using the present CW (without advancing to the next value in the sequence). The QoS Short Retry Counter (QSRC) [AC] for the MAC Service Data Unit (MSDU) or Aggregated-MSDU (A-MSDU) is not affected. When an R-TWT SP commences, an R-TWT scheduled STA may suspend decrementing the backoff counter of any Access Class (AC) that does not have any R-TWT TID(s) mapped to it until it has delivered all its frames from R-TWT TID(s), and resumes decrementing afterwards, or when the SP has ended. To schedule trigger-enabled R-TWT SP, the trigger enabled parameter in the configurable R-TWT schedule parameter should be set to 1. In addition to the general channel access rules, the following rules should also be applied.

When scheduling the transmission of Trigger frames, the R-TWT scheduling AP shall first trigger R-TWT scheduled STAs to first deliver QoS Data frames of R-TWT UL TID(s), if any. The triggered R-TWT scheduled STA shall first include QoS Data frames (if any) of TID(s) in the R-TWT UL TID(s) in the aggregated MPDU. The triggered R-TWT scheduled STA could aggregate multi-TID MPDU. The R-TWT scheduling AP should schedule trigger frames at the start of the R-TWT SPs.

### 3. Problem Statement

The present protocols do not provide for a roaming non-AP MLD transmitting/receiving latency sensitive traffic within its ongoing R-TWT SP and is transmitting from current BSS to another BSS at the same time. After the roaming, there is no R-TWT SP scheduled for the roaming non-AP MLD, and the roaming non-AP MLD needs to negotiate with the AP MLD in the new BSS to set up the R-TWT SP to prioritize its Real-Time Application (RTA) traffic. However, this technology does not achieve smooth roaming and at the same time guarantee the latency performance of the RTA traffic for the roaming non-AP MLD.

### 4. Contribution of the Present Disclosure

The present disclosure is an apparatus, method and protocol to fill the gap when a roaming non-AP MLD is serving DL/UL RTA traffic in an ongoing R-TWT SP and starts roaming, it could achieve smooth roaming while guaranteeing latency performance. An enhanced R-TWT scheduling setup is described which allows roaming of a non-AP MLD to use the enhanced R-TWT SP after roaming to the BSS of the target AP MLD without a further negotiation for an R-TWT SP after roaming. A new TID-to-Global-Link Mapping is proposed to adapt the TID-to-Link Mapping to the new Roaming AP MLD's architecture. New enhanced R-TWT termination rules are designed in this disclosure when the roaming non-AP MLD is moving close to, or across, the edge of the range original associated AP MLD. A new enhanced R-TWT is set with resume/restart rules designed to operate when a roaming non-AP MLD finishes a transition to the BSS of the roaming target AP MLD.

### 5. Hardware Embodiments

### 5.1. Communication Station (STA and MLD) Hardware

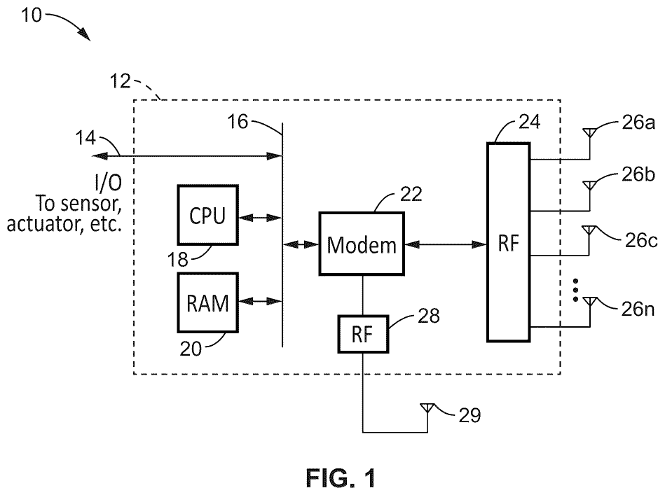

FIG. 1 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

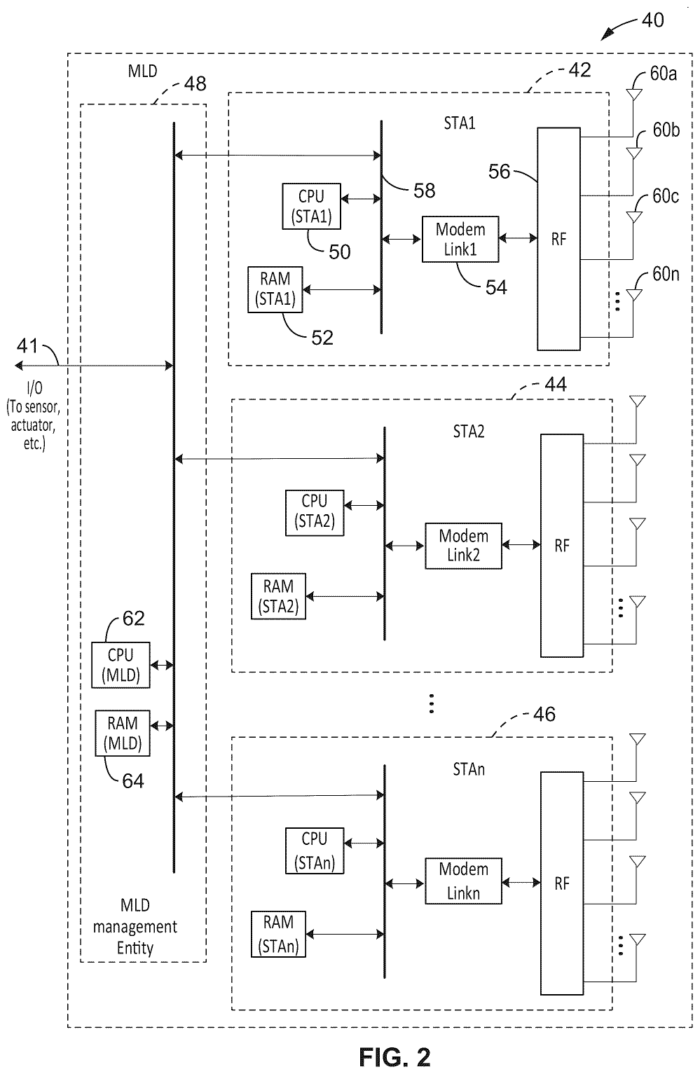

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHZ), basic link set (2.4 GHz and 6 GHZ).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 5.2. Roaming AP MLD Architecture

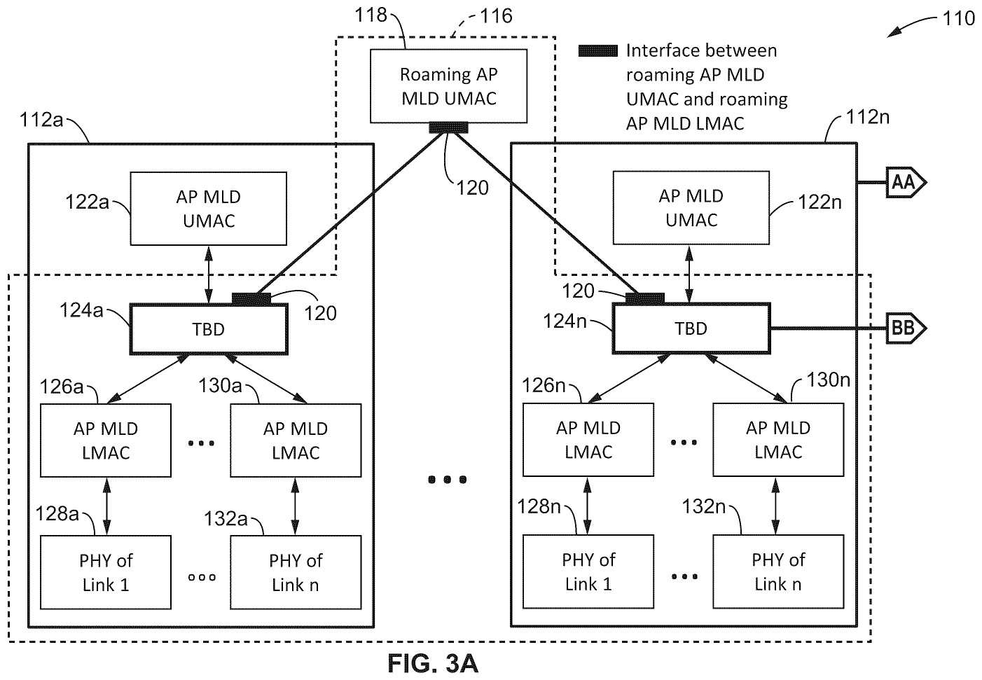

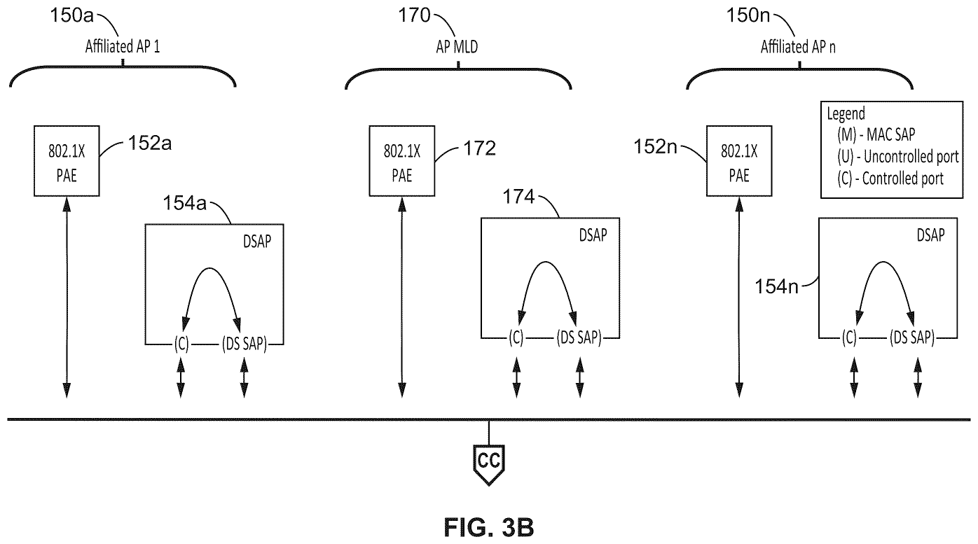

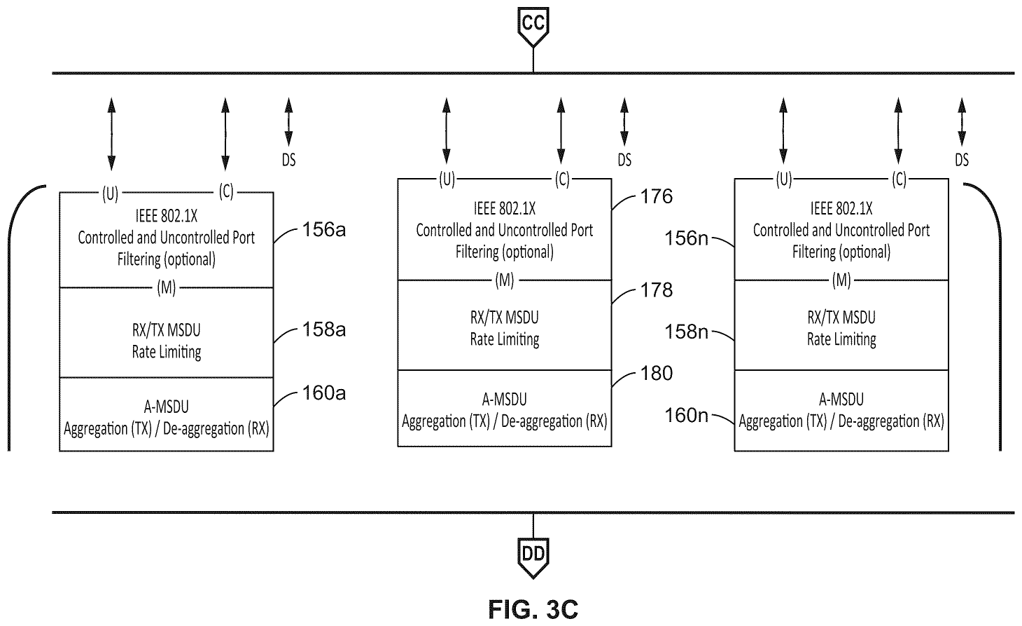

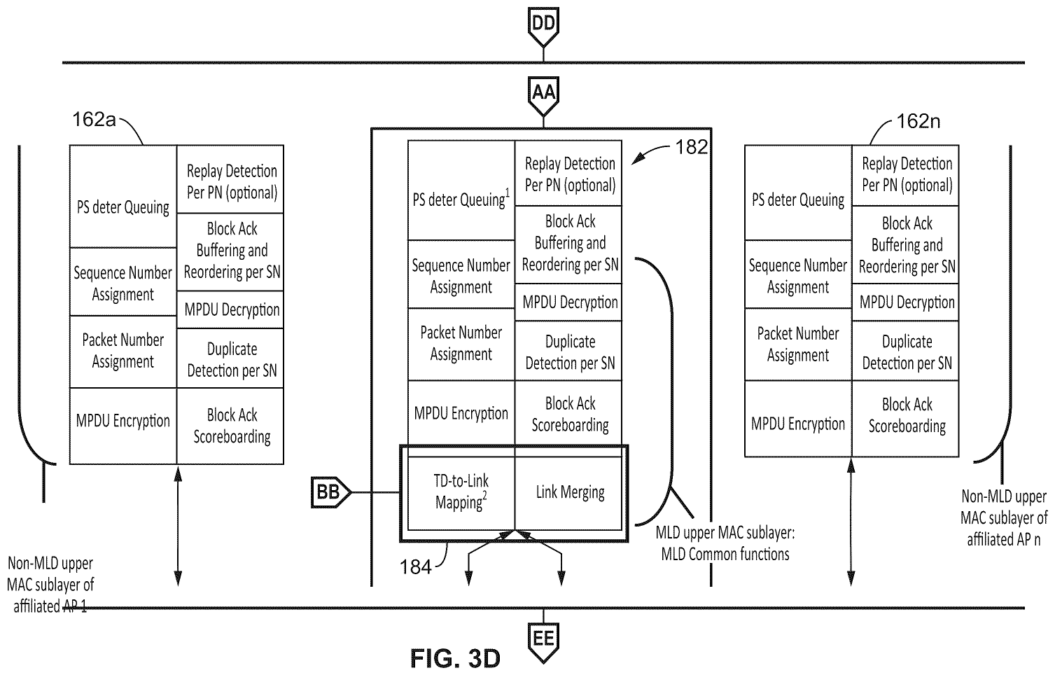

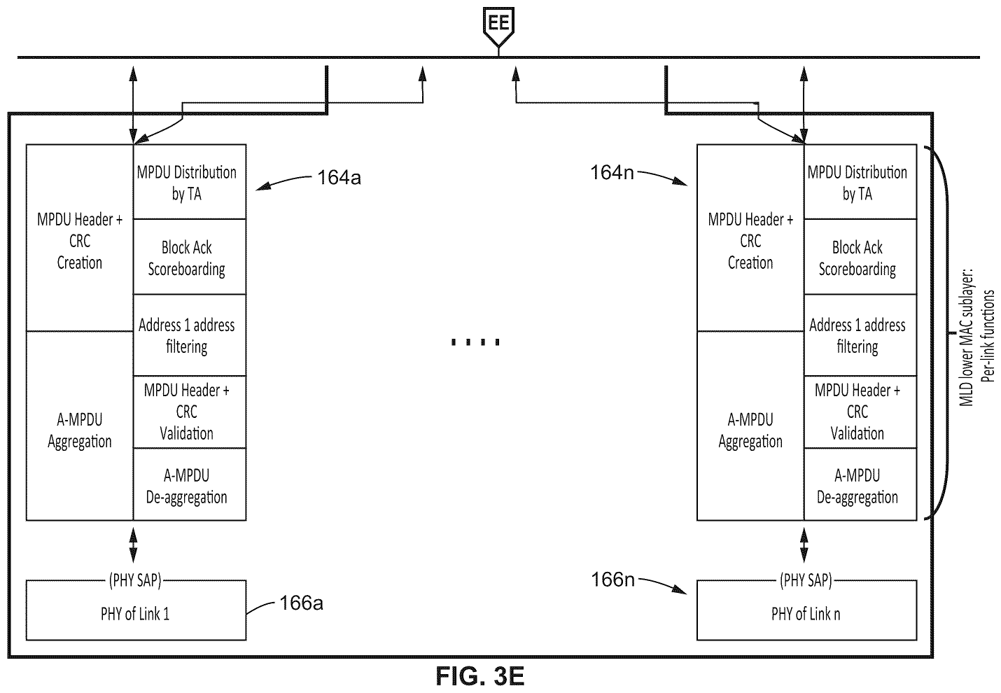

FIG. 3A through FIG. 3E illustrates an example embodiment 110 of a roaming AP MLD architecture according to the present disclosure.

In FIG. 3A is seen a first AP MLD 112a having a UMAC 122a, to which a TBD 124a is connected, which is shown 184 in FIG. 3D as representing TID-to-link mapping and link merging, and lower MAC elements shown with AP MLD LMAC 126a through to AP MLD LMAC 130a, connected to which are seen the physical (PHY) layer control for link 1 128a through to link n 132a.

A neighboring AP MLD 112n may be the roaming target AP MLD, having the same elements with AP MLD UMAC 122n, TBD 124n, AP MLD LMAC 126n through to 130n, over PHY of link1 128n through to PHY of linkn 132n.

A Roaming AP MLD UMAC 118 is shown connecting 116, between the different AP MLDs in different BSS, through interfacing 120 and the dark connecting lines therebetween, into the roaming AP MLD Lower Medium Access protocol (LMAC), which consists of each affiliated AP MLD's AP MLD LMAC 126, 130 and in some cases a portion of the AP MLD Upper-Medium Access Control (UMAC), such as the TID-to-Link mapping and Link Merging layer.

The TID-to-Link mapping and Link Merging can be either in the AP MLD level or in a Roaming AP MLD level. If in AP MLD level, the TBD block should be TID-to-Link mapping and Link Merging. If in a roaming AP MLD level, the TBD block should not be utilized, and the TID-to-Link mapping and Link Merging should be performed inside the Roaming AP MLD UMAC block.

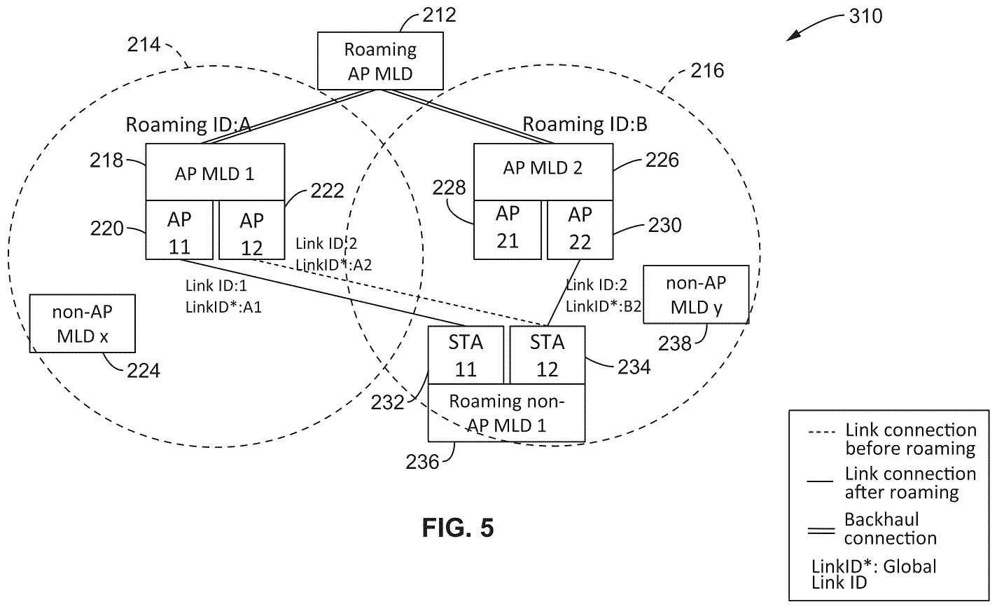

The blocks as shown in FIG. 3B-3E are the same as that shown in FIG. 5-2b-MAC data plane architecture for AP MLD and affiliated APs in Draft P802.11be_D4.0, where the MLD Common functions in FIG. 3D, except for the TID-to-Link Mapping and Link Merging in MLD Upper MAC (UMAC) sublayer could be covered in the AP MLD UMAC in FIG. 3A. The Per-link functions in MLD lower MAC sublayer in FIG. 3E could be covered in the AP MLD Lower MAC (LMAC) blocks in FIG. 3A.

So specifically, starting in FIG. 3B is shown elements for Affiliated APs (AP 1-AP n) 150a-150n, with an 802.1X Port Access Entity (PAE) 152 and Destination Service Access Point (DSAP) 154a-154n, extending into FIG. 3C with optional IEEE 802.1X Controlled and Uncontrolled Port Filtering 156a-156n, Rx/Tx MSDU Rate Limiting 158a-158n, and A-MSDU Aggregation (Tx)/De-aggregation (Rx) 160a-160n, and extending into FIG. 3D block 162a-162n shown with PS Deter Queuing, Sequence Number Assignment, Packet Number Assignment, MPDU Encryption, optional Replay Detection per PN, Block Ack Buffering and Reordering per SN, MPDU Decryption Duplicate Detection per SN, and Block Ack Scoreboarding. This is then shown extending down into the LMAC area connecting into block 164a-164n of FIG. 3E, shown with MPDU Header+CRC Creation, A-MPDU Aggregation, MPDU Distribution by TA, Block Ack Scoreboarding, Address 1 address filtering, MPDU Header+CRC Validation and A-MPDU De-Aggregation. Then from the LMAC it extends to the Physical layer (PHY SAP) in block 166a-166n with PHY of Link 1.

Starting in FIG. 3B is also shown elements for the AP MLD 170, with an 802.1X Port Access Entity (PAE) 172 and Destination Service Access Point (DSAP) 174, extending into FIG. 3C with optional IEEE 802.1X Controlled and Uncontrolled Port Filtering 176, Rx/Tx MSDU Rate Limiting 178, and A-MSDU Aggregation (Tx)/De-aggregation (Rx) 180, and extending into FIG. 3D block 182 shown with PS Deter Queuing, Sequence Number Assignment, Packet Number Assignment, MPDU Encryption, optional Replay Detection per PN, Block Ack Buffering and Reordering per SN, MPDU Decryption Duplicate Detection per SN, and Block Ack Scoreboarding.

In addition to the functions found for the affiliated APs is added 184 TD-to-Link mapping and Link merging, as described elsewhere.

### 6. Example Topologies

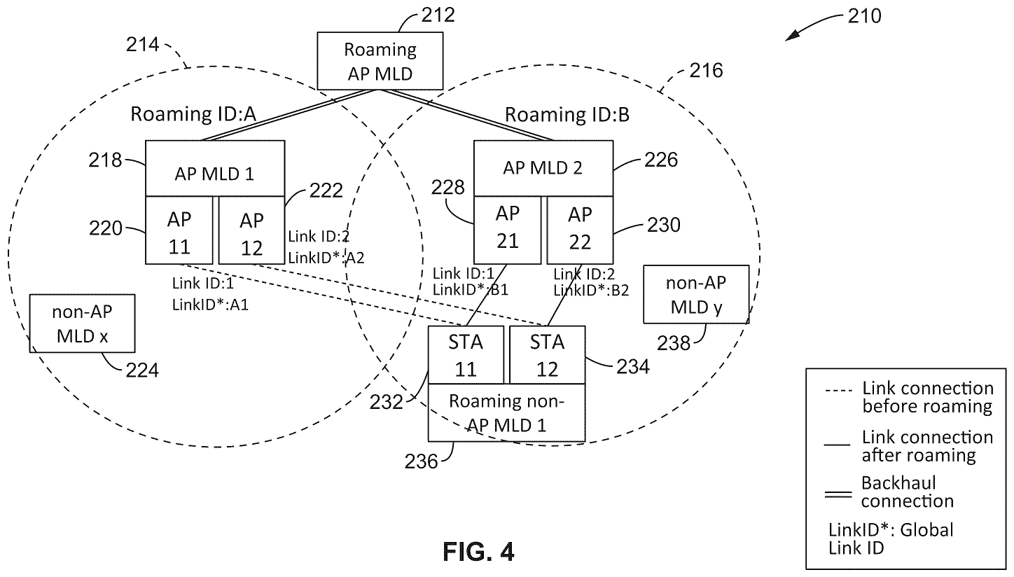

FIG. 4 and FIG. 5 illustrate example topologies 210, 310, which are provided, by way of example and not limitation, as an aid for discussing operations.

In FIG. 4 two BSSs 214, 216 are shown with their AP MLDs, which are connected though the backhaul control link (double lines) with a central controller called a Roaming AP MLD 212. In BSS 214 is shown AP MLD 1 218, while the second BSS 216, has AP MLD 2 226 affiliated with the same Roaming AP MLD. AP MLD 1 has two affiliated APs, AP11 220 and AP12 222, which operate on the links identified as link ID 1 and link ID 2, shown with dashed lines, wherein local link ID can be recognized by AP MLD 1. AP MLD 2 has two affiliated APs, AP21 228 and AP22 230, which operate on the links identified as link ID 1 and link ID 2, shown with solid lines, wherein local link ID is recognized by AP MLD 2. AP MLD 1 has been assigned a Roaming ID as A; AP MLD 2 has been assigned a Roaming ID as B. With the Roaming ID, the links where AP11, AP12, AP21 and AP22 operate can be identified with a global link ID as A1, A2, B1 and B2 respectively. The global link ID can be recognized by the Roaming AP MLD, AP MLD 1 and AP MLD 2.

In this example, the Roaming non-AP MLD 1 236 roams from the BSS of AP MLD 1 to the BSS of AP MLD 2. The roaming non-AP MLD 1 has two affiliated STAs, STA11 232 and STA12 234, which operate on the links identified as link ID 1 and link ID 2 (local link ID recognized by roaming non-AP MLD 1 and associated AP MLDs). The roaming non-AP MLD 1 can also recognize the global link ID.

Non-AP MLD x 224 is associated with AP MLD 1, while non-AP MLD y 238 is associated with AP MLD 2.

In FIG. 4, before roaming, STA11 is associated with AP11 while STA12 is associated with AP12. After roaming (as seen in the figure), STA11 is now associated with AP21 instead of AP11, and STA12 associated with AP22 instead of AP12.

In FIG. 5 we see the same topology and elements as in FIG. 4, but with different link usage in the roaming. Before roaming, STA11 is associated with AP11 while STA12 is associated with AP12. After roaming (as shown in the figure), STA11 is still associated with AP11 instead of AP21 and STA12 is now associated with AP22 instead of AP12.

### 7. Protocol Description

7.1. UORA with Fast BSS Transition

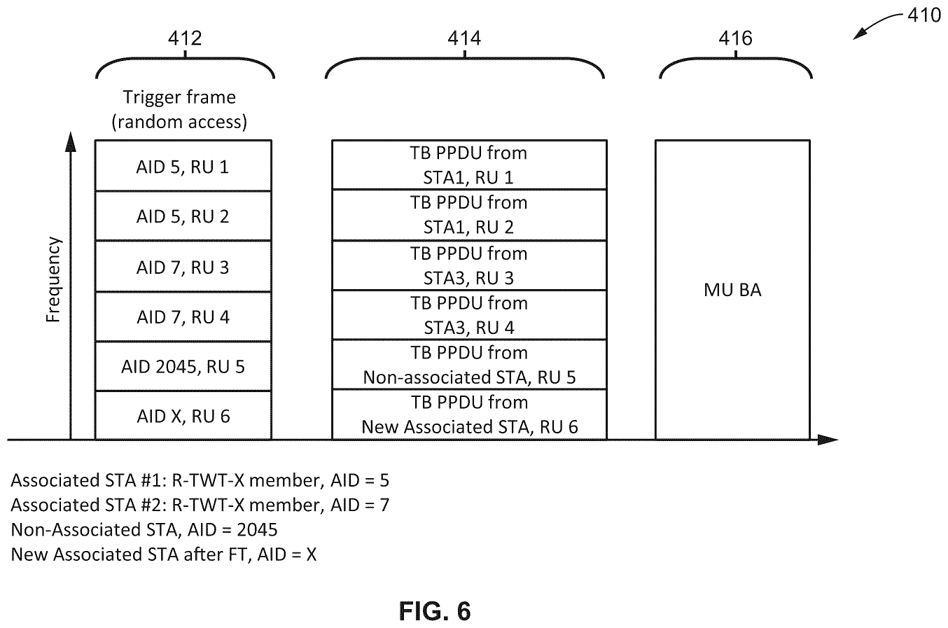

FIG. 6 illustrates an example embodiment 410 of UORA after non-AP MLD roaming. The figure illustrates Trigger frames 412, TB PPDUs 414, and a MU Block Acknowledgement 416. The ordering is shown in the figure according to increasing frequency in the y axis.

UORA should be enabled in the R-TWT SP and allocating a Resource Unit (RU) with AID12=X for new associated STA, usually after a Fast BSS Transition (FT), and without a granted R-TWT membership of this R-TWT SP.

AID12 subfield equals to a specific value (e.g., 2045) indicates that the User Info field allocates one or more contiguous RA-RUs for unassociated STAs.

AID12 subfield equals to a value of X, which could be any valid value from the reserved values (i.e., 2008-2044, 2047-4094), is used to indicate that the User Info field allocates one or more contiguous RA-RUs for new associated STAs after FB but without obtaining an R-TWT membership in the current R-TWT SP.

If the roaming AP MLD is aware that the non-AP MLD is roaming from BSS(s) of one of its affiliated AP MLD (e.g., AP MLD11) to the BSS(s) of another of its affiliated AP MLD (e.g., AP MLD12), the roaming AP MLD should signal the target AP MLD (e.g., AP MLD12) of the roaming non-AP MLD, through the backhaul, to instruct the target AP MLD to maintain (retain) a certain amount of RUs for non-associated STAs and/or for new associated STAs that haven't established an R-TWT membership to be able to obtain random channel access opportunities in the following TB-PPDUs. The UORA procedure can be performed inside or outside of a R-TWT SP.

The non-AP MLD obtains an RU after roaming and can send the target AP MLD a Buffer Status Report (BSR) and its AID if the non-AP MLD has established the association with the target AP MLD, or a temporary AID if the non-AP MLD hasn't established an association to the target AP MLD and the temporary AID could be understand by either the target AP MLD or the roaming AP MLD in the TB PPDU to request the target AP MLD to allocate more RUs, which could be unicast RUs to it.

### 7.2. Scheduling Enhanced R-TWT SP at Roaming AP MLD Level

The non-AP MLD can negotiate an R-TWT at the roaming AP MLD level. The roaming AP MLD can maintain an awareness of R-TWT scheduling for each affiliated AP MLD, and can synchronize them; such as using a Timing Synchronization Function (TSF), to establish the timing of each affiliated AP MLD to the same benchmark.

There are advantages to the above approach, as follows. (a) There is no need to negotiate an R-TWT with the new AP MLD after roaming, whereby communication latency is reduced. (b) The roaming AP MLD can either schedule a R-TWT SP that is accepted by all affiliated AP MLDs and can be fit in all schedules of affiliated AP MLDs, for example scheduling a universal enhanced R-TWT, or it may at once schedule a non-universal enhanced R-TWT SP along with setting up different R-TWT schedules corresponding to the affiliated AP MLDs, at the roaming AP MLD level.

Disadvantages to this approach are as follows. (a) The TID-to-Link Mapping and Link Merging can be performed at the AP MLD level. (b) If the TID-to-Link mapping and Link Merging is at an AP MLD level, then the roaming AP MLD needs to be able to unify the link IDs by using global link identification methods. In at least one embodiment, if in the roaming AP MLD level, the link ID is already a global link ID. The global link ID of a link can be used/derived from the AP MLD RoamingID of the AP MLD+Link ID, where AP MLD RoamingID is the unique ID allocated by the roaming AP MLD to each AP MLD affiliated with it. (c) A new TID-to-Global-Link Mapping should be designed/configured to indicate the links, which are identified by global link IDs, upon which frames belonging to each TID can be exchanged. The links with global link ID can be links from any AP MLD affiliated with the Roaming AP MLD and that have an AP MLD Roaming ID.

The APs affiliated with the roaming AP MLD can either schedule universal enhanced R-TWT SPs on the setup link or multiple links if aligned R-TWT schedules are setup, or schedule non-universal enhanced R-TWT SP with multiple different R-TWT SPs corresponding to each AP, that is affiliated with different AP MLD of the roaming AP MLD.

### 7.2.1. TIF-to-Global-Link Mapping (TTGLM)

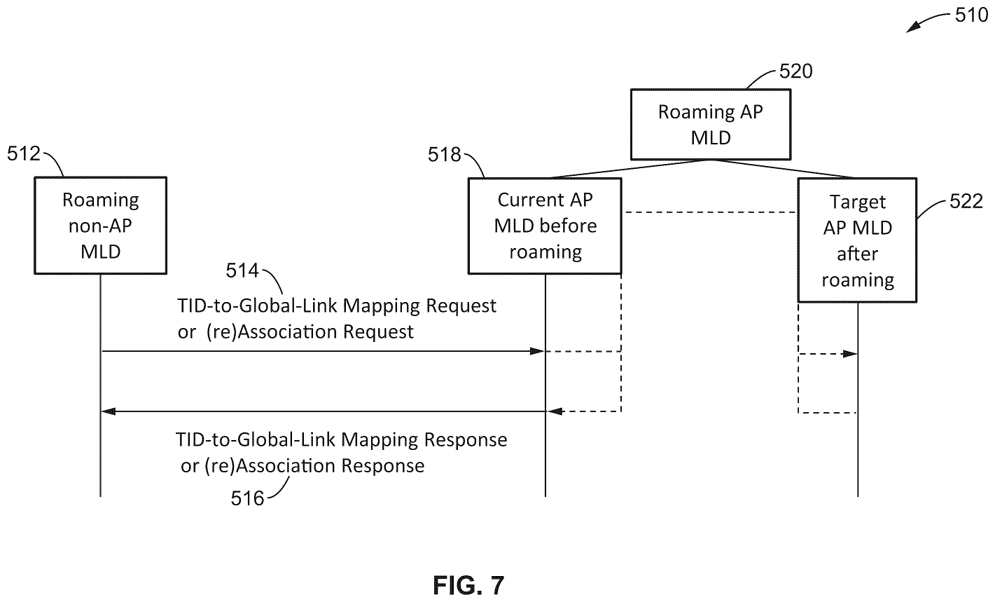

FIG. 7 illustrates an example embodiment 510 of negotiation of TID-to-Global-Link Mapping (TTGLM). The Roaming non-AP MLD 512, Roaming AP MLD 520 and the affiliated AP MLDs 518, 522, of the Roaming AP MLD should support the TID-to-Global-Link Mapping (TTGLM) negotiation if the TID-to-Link mapping and Link Merging MAC functions are at the AP MLD level. The TTGLM negotiation can be processed during ML (re) setup, wherein a non-AP MLD may initiate a TTGLM negotiation by including the proposed TID-to-Global-Link Mapping element in the negotiation frames.

The present disclosure provides a new TTGLM element designed to indicate the links, which are identified by global link IDs, on which frames belonging to each TID can be exchanged.

The Roaming non-AP MLD can negotiate the TTGLM with the Roaming AP MLD through the relay of its associated AP MLD to set up TTGLM with any AP MLD affiliated with the Roaming AP MLD.

The TTGLM negotiation of the TID-to-Global-Link Mapping can be processed by exchanging of a TID-To-Global-Link Mapping Request frame 514 and a TID-To-Global-Link Mapping Response frame 516 that carries the TID-to-Global-Link Mapping element.

The TTGLM negotiation can also be processed by exchanging (re) Association Request frame and (re) Association Response frames that carries the TID-to-Global-Link Mapping element.

As shown in FIG. 7, a Roaming non-AP MLD 512 sends a TID-to-Global-Link Mapping Request frame or (re) Association Request Frame 514 to the current AP MLD 518, before roaming, to initiate TTGLM negotiation. The Roaming AP MLD 520 can maintain information on all global links, so the negotiation can be processed between the roaming non-AP MLD 512 and the Roaming AP MLD 520. The current AP MLD 518 can facilitate the process by relaying the negotiation information.

In response to receiving a TID-To-Global-Link Mapping Request frame 514, a TID-To-Global-Link Mapping Response frame or (re) Association Response frame 516 is sent by the current AP MLD 518 on behalf of the Roaming AP MLD 520 to indicate acceptance or rejection of a proposed TTGLM, or to suggest a preferred TTGLM.

### 7.3. Scheduling a New R-TWT SP at the AP MLD Level

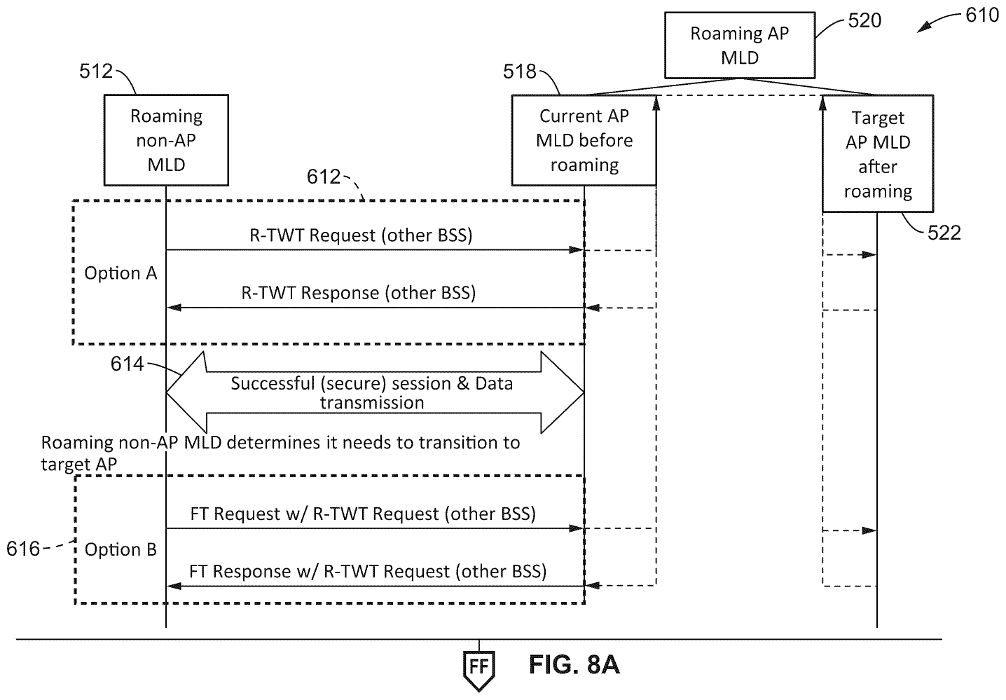

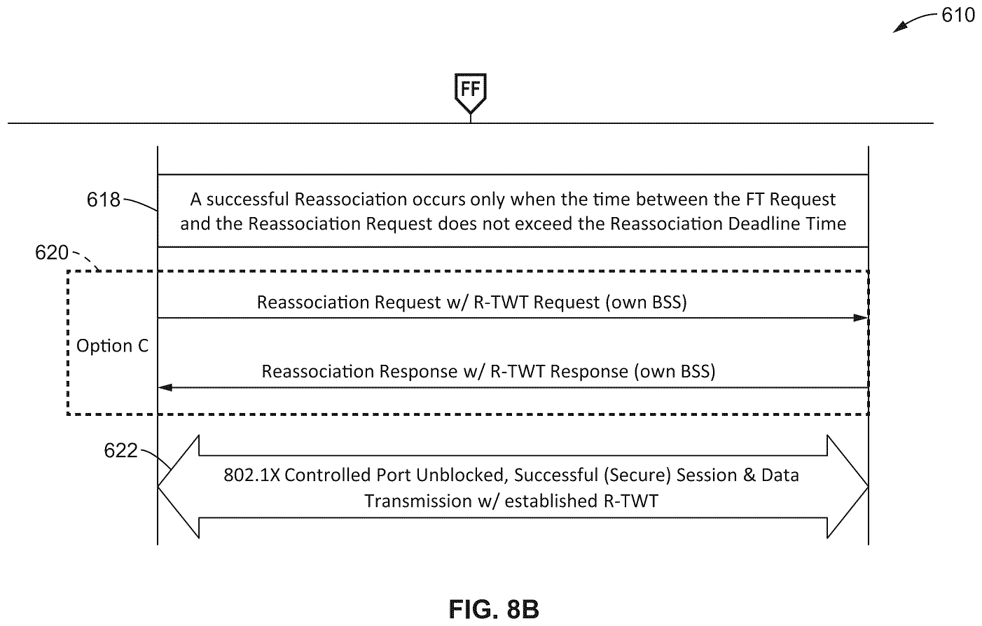

FIG. 8A through FIG. 8B illustrate an example embodiment 610 of enhanced R-TWT negotiation between roaming non-AP MLD 512 and its associated AP MLD 518, through a roaming AP MLD 520, on behalf of the target AP MLD 522.

In FIG. 8A it is seen that before, or during, roaming to the BSS of the target AP MLD 522, the non-AP MLD 512 can negotiate an enhanced R-TWT with the target AP MLD, through the relaying of its associated AP MLD and the Roaming AP MLD. The negotiation can be processed before the non-AP MLD finishes roaming to the target AP MLD.

As shown in the figure there are three options in this disclosure for providing enhanced R-TWT negotiation.

Option A 612: before roaming, the current AP MLD 518 negotiates an R-TWT schedule with non-AP MLD on behalf of the Target AP MLD. The figure depicts the negotiation as an R-TWT Request, and associated R-TWT Response.

Non-AP MLD can start an Option A procedure when it is getting close to the edge of the current BSS, and it keeps roaming towards a target BSS 522. The roaming STA affiliated with a roaming non-AP MLD 520 can determine if it is moving closer to the edge of the associated BSS based on several criteria including, but not limited to: throughput and/or packet loss rate of its transmission, the RSSI of the received Ack/(MU) BA as the response of its transmitted (MU) PPDU, the detection of OBSS signals, in terms of the RSSI of the signal, the frequency of the detection of OBSS signals, and so forth, as well as the roaming signal from the co-located STA which is affiliated with the same roaming non-AP MLD.

After negotiation, a successful (secure) session and data transmission 614 are shown taking place.

Option B 616: during roaming, or Fast BSS Transition (FT), the current AP MLD 518 negotiates an R-TWT schedule with the non-AP MLD 512 on behalf of the Target AP MLD 522 along with the exchange of FT Request and FT Response Frames. The figure notes 618 (in FIG. 8B) that a successful Reassociation occurs only when the time between the FT Request and Reassociation Request does not exceed the Reassociation Deadline Time.

Option C 620 in FIG. 8B: at the end of roaming, the non-AP MLD 512 directly negotiates an enhanced R-TWT schedule with the target AP MLD, through the exchange of Reassociation Request and Reassociation Response Frames that carry the enhanced R-TWT element. Thus, the figure shows 622 that 802.1X controlled port is unblocked, and successful (secure) session and data transmission can be performed with the established R-TWT.

### 7.4. Enhanced R-TWT SP Rules for Roaming

This section describes enhanced R-TWT SP termination and initiation rules for achieving smooth roaming, in which the transition from current to target AP MLD progresses without errors or undue delays.

The Enhanced R-TWT SP termination and initiation rules for smooth roaming can be independently configured for different topologies, including roaming non-AP MLD with single serving AP MLD, as shown in FIG. 4, and roaming non-AP MLD with multiple serving AP MLDs, as shown in FIG. 5.

The roaming STA affiliated with a roaming non-AP MLD can identify if it is moving closer to the edge of the associated BSS based on several criteria, which include but are not limited by the following: (a) based on the throughput and/or packet loss rate of its transmission; (b) based on the RSSI of the received Ack/(MU) BA as the response of its transmitted (MU) PPDU; (c) based on the RSSI of the received preemption Ack/(MU) BA as the response of its transmitted (MU) PPDU w/empty frequency/time slot for preemption; (d) based on the detection of OBSS signals, in terms of the RSSI of the OBSS signal, the frequency of the detection of OBSS signals, and so forth; (e) based on the roaming signal from the co-located STA which affiliated with the same roaming non-AP MLD.

7.4.1. Rules for Roaming Non-AP MLD with Single Serving AP MLD

### 7.4.1.1. Terminating R-TWT SP or Suspending R-TWT Membership of Roaming Non-AP MLD of Ongoing R-TWT SP Before Roaming

The roaming non-AP MLD should have at least one link for exchanging the (MU) PPDU with an empty frequency/time slot and Ack or (MU) BA that would preempt the empty frequency/time slot to enable the affiliated roaming STA on that link to keep tracking the frames from its associated AP to decide if it should stop transmission within the ongoing R-TWT SP in the current BSS and initiate a BSS transition to the targeted BSS and then resume R-TWT SP in the new BSS.

The roaming non-AP MLD can send a frame, such as a CF-end, to its associated AP MLD to indicate it no longer needs to be served by the ongoing R-TWT SP, which is scheduled on its operational link and the other links if an aligned R-TWT schedule was setup for its affiliated non-AP MLD. The AP MLD receives the CF-end frame that is addressed to it and should terminate the current R-TWT SP on all scheduled links unless there are other R-TWT members of this R-TWT SP which still are maintaining this R-TWT SP.

After roaming, the non-AP MLD can send a frame, such as CF-end, to its associated AP MLD to indicate it no longer needs to be served by the ongoing aligned R-TWT SP on multiple links. If there are other R-TWT members of this R-TWT SP which still need to maintain this R-TWT SP, the AP MLD which received the CF-end frame should suspend the R-TWT membership for the source non-AP MLD of the CF-End frame and should keep processing the R-TWT SP for other R-TWT members. The roaming non-AP MLD should start a BSS transition if it obtains channel access, which can be inside or outside the R-TWT SP, to which it gives up its membership.

7.4.1.2. Resuming/Restarting R-TWT SP for Roaming Non-AP MLD after Roaming

After the roaming non-AP MLD finishes its transition to the target BSS, if there is no ongoing R-TWT SP in the new BSS, then the AP MLD of the new BSS and/or the roaming non-AP MLD should Resume or Restart the R-TWT SP based on the predetermined enhanced R-TWT schedule without further negotiation.

For the scheduled universal enhanced R-TWT SP, the R-TWT SP scheduled for the roaming non-AP MLD in the target BSS can be a continued R-TWT SP with previous R-TWT SP of the non-AP MLD in the previous associated BSS before roaming.

For the non-universal enhanced R-TWT that has multiple different R-TWT SPs corresponding to each AP MLDs, the enhanced R-TWT SP scheduled for the roaming non-AP MLD in the target BSS may not start until the roaming non-AP MLD roams to the target BSS. At which time the AP MLD of the target BSS can apply UORA for the roaming non-AP MLD to continue sending out low latency traffic, as introduced in Section 7.1. The AP MLD of the target BSS should also start the predetermined R-TWT SP for the roaming non-AP MLD in its BSS.

After the roaming non-AP MLD finishes its transition to the target BSS, if there is an existing ongoing R-TWT SP in the new BSS, which is not the same as the predetermined R-TWT SP for the roaming non-AP MLD, the target AP can grant the roaming non-AP MLD a temporary membership of the ongoing R-TWT SP, while also maintaining the predetermined R-TWT SP for this roaming non-AP MLD. If the existing ongoing R-TWT SP in the new BSS is the same as the predetermined R-TWT SP for the roaming non-AP MLD, the target AP MLD should trigger the roaming non-AP MLD as the member and the roaming non-AP MLD should access the medium during the R-TWT SP with the R-TWT member priority.

Considering the possibility that the medium may have a busy status and cannot be immediately accessed at the beginning of the resumed/restarted R-TWT SP in the roaming target BSS, the transmission of the roaming non-AP MLD trigger from the roaming non-AP MLD, should be processed at the earliest time whenever the roaming non-AP MLD or the targeting AP MLD obtains channel access in an EDCA-based R-TWT SP or in a Trigger-enabled R-TWT SP, respectively. Thus, non-synchronized channel access start time of the roaming non-AP MLD or the target AP MLD on different links within the resumed/restarted R-TWT SP should be acceptable.

The duration of the resumed/restarted periodical R-TWT SP in the target BSS can be set as the predetermined enhanced R-TWT SP duration as defined in the setup procedure without considering the time used by the roaming non-AP MLD in the previous associated BSS within its R-TWT SP before roaming. Except for the 1st R-TWT SP of this periodical R-TWT SP sequence. The duration of the 1st R-TWT SP can be set with or without consideration of the amount of time which has passed in the R-TWT SP Duration that the roaming non-AP MLD was used in the previous associated BSS before roaming. The non-AP MLD can terminate its R-TWT SP at anytime based on its need.

7.4.2. Rules for Roaming Non-AP MLD with Multiple Serving AP MLDs

During roaming, the roaming non-AP MLD should maintain at least one link as connected with the originally associated AP MLD and continue the scheduled R-TWT SP on the maintained link(s) to transmit or receive low latency traffic to, or from, the original associated AP MLD, respectively. The roaming non-AP MLD should use the remaining links to establish connection with the roaming target AP MLD. For the link(s) that are utilized to establish the connection to the roaming target AP MLD, they are to terminate R-TWT SP, or suspend R-TWT membership, of the ongoing R-TWT SP before roaming and resume/restart the R-TWT SP after roaming for the STA(s) affiliated with the roaming non-AP MLD on the link(s) which are the same as that described in Section 7.4.1. The roaming non-AP MLD can continue maintaining the link(s) with the original associated AP MLD and continue the previous R-TWT schedule on that link(s) even it has finished establishing the connection using the remaining link(s) with the roaming target AP MLD.

### 8. Protocol Flow Diagrams

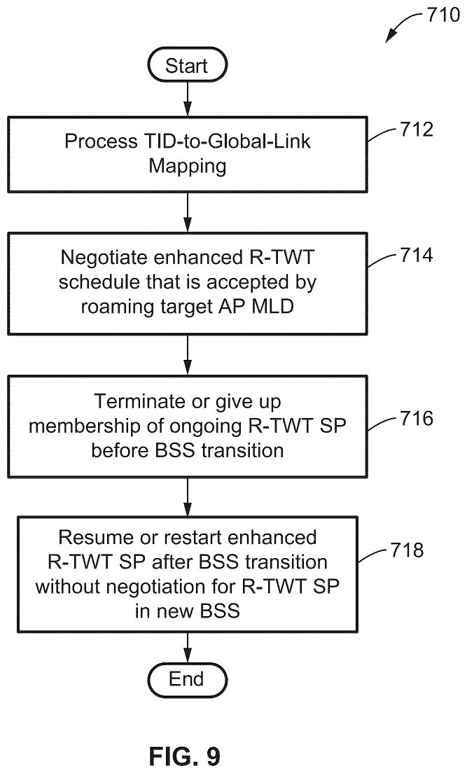

FIG. 9 illustrates an example embodiment 710 for roaming a non-AP MLD. TID-to-Global-Link mapping is processed 712 by the non-AP MLD. In block 714 negotiation is performed to obtain an enhanced R-TWT schedule that is acceptable to the roaming target AP MLD. Then the non-AP MLD terminates, or surrenders (gives up) 716 its ongoing R-TWT SP before the BSS transition occurs. After which the non-AP MLD resumes or restarts 718 the enhanced R-TWT SP after the BSS transition without negotiation for R-TWT SP in the new BSS.

### 9. Frame Formats

### 9.1. TID-To-link Global Mapping Element

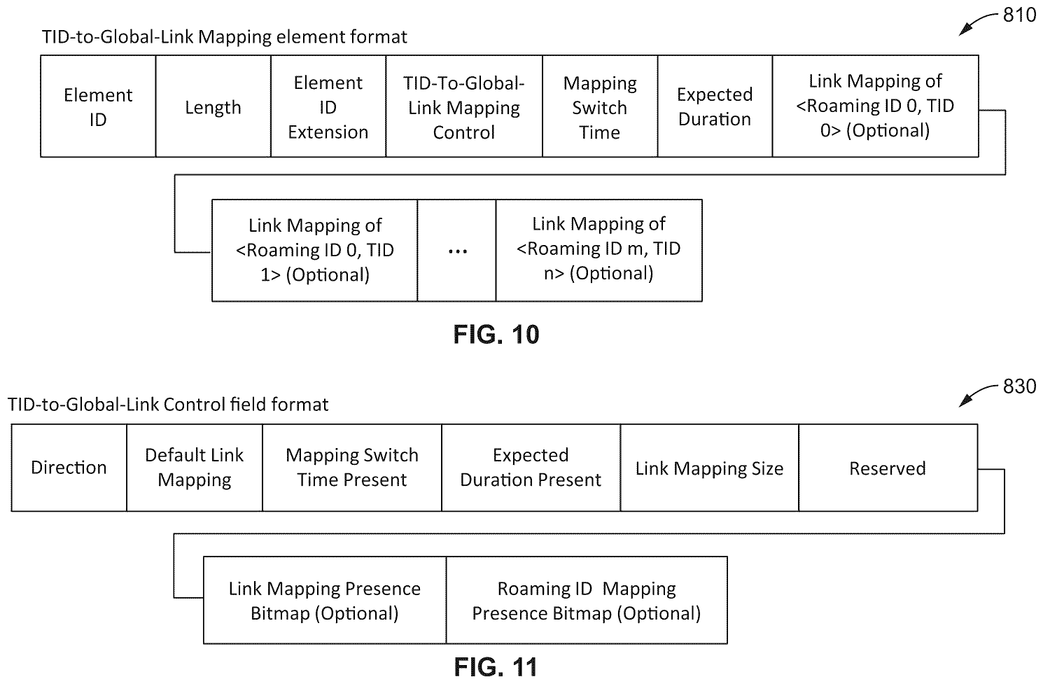

FIG. 10 illustrates an example embodiment 810 of a TID-to-Global-Link Mapping element format. The subfields are shown to be Element ID, Length, Element ID Extension, TID-to-Global Mapping control, Mapping Switch Time, Expected Duration, Link Mapping of <Roaming ID 0, TID 1 (optional), and through to Link Mapping of <Roaming ID m, TID n (optional).

Many of these fields are as found in IEEE 802.11BE Draft P802.11be_D4.0.pdf, however, the TID-to-Global Mapping control, Link Mapping of <Roaming ID 0, TID 1 (optional), and through to Link Mapping of <Roaming ID m, TID n (optional) are all new in the present disclosure.

FIG. 11 illustrates an example embodiment 830 of the TID-to-Global-Link Control field as was shown in FIG. 10, and has the following subfields: Direction, Default Link Mapping, Mapping Switch Time Present, Expected Duration Present, Link Mapping Size, Reserved, Link Mapping Presence Bitmap (optional) and Roaming ID Mapping Presence Bitmap (optional). The subfields of Link Mapping Presence Bitmap (optional) and Roaming ID Mapping Presence Bitmap (optional), are new in this present disclosure.

In the TID-to-Global-Link Mapping element, the Link Mapping of AP MLD Roaming ID m and TID n is presented as a tuple, shown as Link Mapping of <Roaming ID m, TID n>, as a Link Mapping of <Roaming ID m, TID n> field (where m=0, 1, . . . , n=0, 1, . . . , 7) indicates the link(s) on which frames belonging to <Roaming ID m, TID n> are allowed to be sent (i.e., carries a bitmap of the links to which the <roaming ID m, TID n> tuple is mapped to). A value of a first state (e.g., ‘1’) in bit position i (where if the Link Mapping Size subfield is set to 1, and otherwise) of the Link Mapping Of <Roaming ID m, TID n> field indicates that TID n is mapped to the link associated with the link ID i for the AP MLD identified by Roaming ID m and for the direction as specified in the Direction subfield. A value of a second state (e.g., ‘0’) in bit position i indicates that the TID n is not mapped to the link associated with the link ID i for the AP MLD identified by Roaming ID m for the direction as specified in the Direction subfield. When the Default Link Mapping subfield is set to 1, no Link Mapping of <Roaming ID m, TID n> field is present.

The Link Mapping Presence Bitmap subfield of TID-to-Global-Link Control field indicates which of the Link Mapping of TID n are present in the TID-To-Global-Link Mapping element. A value of 1 in bit position n of the Link Mapping Presence Bitmap subfield indicates that the Link Mapping of <Roaming ID m, TID n> field is present in the TID-To-Link Mapping element. Otherwise, the Link Mapping of <Roaming ID m, TID n> field is not present in the TID-To-Global-Link Mapping element. When the Default Link Mapping subfield is set to 1, this subfield is not present.

The Roaming ID Mapping Presence Bitmap subfield of TID-to-Global-Link Control field indicates which of the link mapping of Roaming ID m are present in the TID-to-Global-Link Mapping element. A value of 1 in bit position m of the Roaming ID Mapping Presence Bitmap subfield indicates that the Link Mapping of <Roaming ID m, TID n> field is present in the TID-To-Global-Link Mapping element. Otherwise, the Link Mapping of <Roaming ID m, TID n> field is not present in the TID-To-Global-Link Mapping element. When the Default Link Mapping subfield is set to 1, this subfield is not present. When the TID-to-Link mapping and Link Merging is in the roaming AP MLD level then this subfield is not present.

### 9.2. Enhanced TWT Element

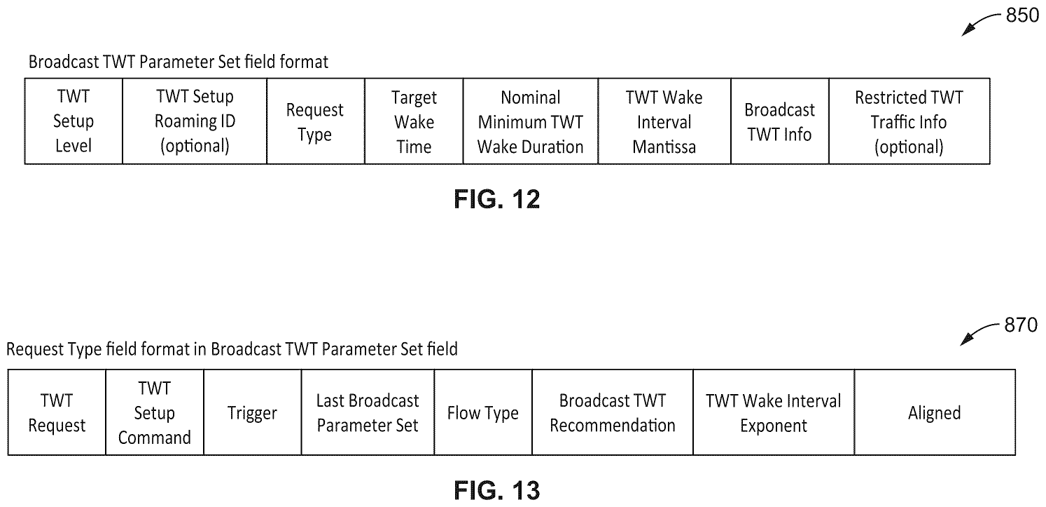

FIG. 12 illustrates an example embodiment 850 of a Broadcast TWT Parameter Set field format, which has been enhanced and has the following fields: TWT Setup Level, TWT Setup Roaming ID (optional), Request Type, Target Wake Time, Nominal Minimum TWT Wake Duration, TWT Wake Interval Mantissa, Broadcast TWT Info, and Restricted TWT Traffic Info (optional). Of these fields the TWT Setup Level and TWT Setup Roaming ID (optional) of are new in this present disclosure.

TWT Setup Level subfield of the Broadcast TWT Parameter Set field indicates in which level the enhanced R-TWT is setup, which includes: Roaming AP MLD level (e.g., value=‘1’), AP MLD level (e.g., value=‘2’). It should be noted that, although it is presented in the MLD level, unless the Aligned subfield of the Request Type field format in Broadcast TWT Parameter Set field is set to 1, the setup of enhanced R-TWT SP is actually at the link level on the setup link between the enhanced R-TWT scheduled STA affiliated with the non-AP MLD and the enhanced R-TWT scheduling AP affiliated with the AP MLD or further affiliated with the roaming AP MLD.

The TWT Setup Roaming ID subfield of the Broadcast TWT Parameter Set field indicates the specific AP MLD, as identified by the TWT Setup Roaming ID, that the enhanced R-TWT is setup as a single link or multiple link enhanced R-TWT SP(s) with.

If the TWT Setup Level subfield indicates the enhanced R-TWT is setup at the Roaming AP MLD level, the TWT Setup Roaming ID subfield is not present. Which means the setup universal or non-universal enhanced R-TWT SP for all affiliated AP MLD of the Roaming AP MLD.

If the TWT Setup Level subfield indicates the enhanced R-TWT is setup at the AP MLD level, and the setup is with the current associated AP, the TWT Setup Roaming ID subfield is not present. This is equivalent to setup an R-TWT SP with the R-TWT scheduler AP.

If the TWT Setup Level subfield indicates that the enhanced R-TWT is setup at the AP MLD level, which affiliates with the same Roaming AP MLD as the current associated AP MLD, then the TWT Setup Roaming ID subfield indicates the Roaming ID of that AP MLD with which the enhanced R-TWT is setup with.

If the TWT Setup Level subfield indicates the enhanced R-TWT is setup at the AP MLD level and the Last Broadcast Parameter Set in the Request Type field format in Broadcast TWT Parameter Set field is set to 0, it indicates that another Broadcast TWT Parameter set follows this set, which could be another enhanced R-TWT SP setup with a different AP MLD identified by the TWT Setup Roaming ID in Broadcast TWT Parameter Set field format. The Last Broadcast Parameter Set subfield is set to 1 to indicate that this is the last broadcast TWT Parameter set in the broadcast TWT element.

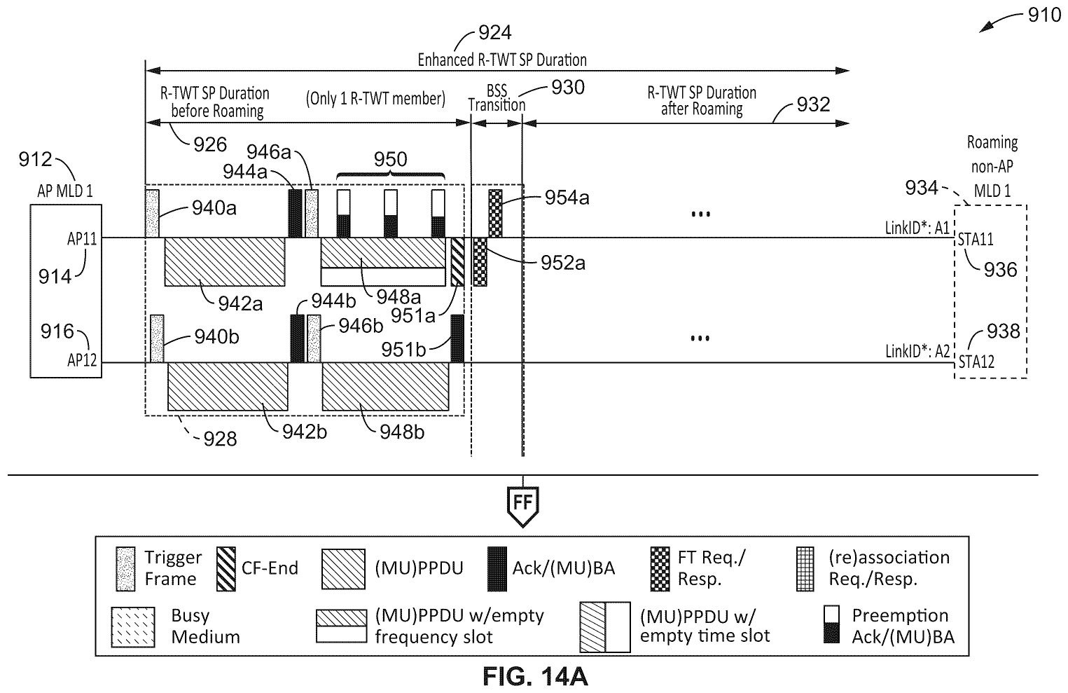

FIG. 13 illustrates an example embodiment 870 of the Request Type field format in Broadcast TWT Parameter Set field of FIG. 12, having the following subfields: TWT Request, TWT Setup Command, Trigger, Last Broadcast Parameter Set, Flow Type, Broadcast TWT Recommendation, TWT Wake Interval Exponent, and Aligned. Of these the subfields of Last Broadcast Parameter Set and Broadcast TWT Recommendation are new in this present disclosure.

In the Broadcast TWT Recommendation subfield of the Request Type field format in Broadcast TWT Parameter Set field, a value should be used from the reserved values (i.e., values from ‘5-7’), to indicate the corresponding broadcast TWT SP is referred to as an enhanced R-TWT SP. During an enhanced R-TWT SP, the enhanced R-TWT scheduled STA and the scheduler roaming AP MLD or the scheduler AP MLD affiliate with the roaming AP MLD prioritizes the transmission of QoS Data frames of latency sensitive traffic and provides for smooth roaming for the prioritized traffic of these transmissions.

### 10. Roaming Examples

### 10.1. MLD Level Terminate and Start R-TWT SP of Roaming

The following examples illustrate MLD level termination and start an R-TWT SP of roaming a non-AP MLD before and after roaming, in which the non-AP MLD is affiliated with a single AP MLD.

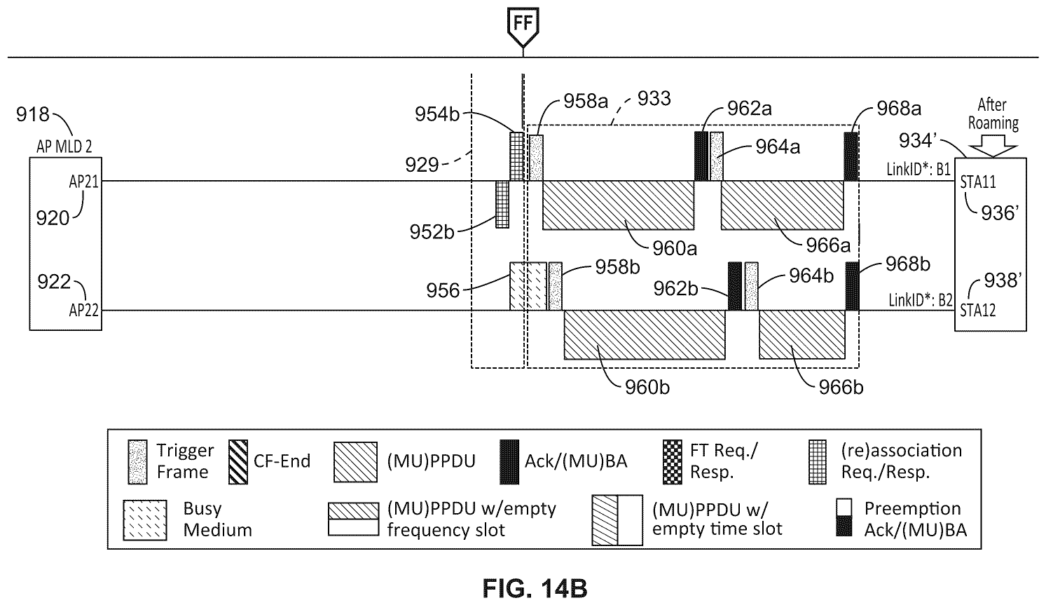

FIG. 14A and FIG. 14B illustrate an example embodiment 910 of MLD level starting and terminating a R-TWT SP for a roaming non-AP MLD before and after roaming with frequency preemption before roaming. This example is based on the topology of non-AP MLD affiliate with single AP MLD, as shown in FIG. 4.

The figure depicts operations between two BSS, with AP MLD 1 912 shown in FIG. 14A and being in the first BSS, and AP MLD 2 918 shown in FIG. 14B and being in the second BSS. AP MLD 1 has two affiliated APs as AP11 914 and AP12 916, and AP MLD 2 also has two affiliated APs as AP21 920 and AP22 922. The figure also depicts the APs communicating with the Roaming non-AP MLD 1 934, having STA11 936 and STA12 938, both before 934, and after 934′ roaming. This non-AP MLD is depicted with STA 11 936 and STA 12 938 before roaming and STA 11 936′ and STA 12 938′ after roaming.

The roaming non-AP MLD 1 roams from the BSS of AP MLD 1 to the BSS of AP MLD 2. Non-AP MLD 1 is within an ongoing trigger-enabled R-TWT SP 924 on link A1 and link A2 when the roaming starts. Three main sections are seen in the figure with R-TWT SP Duration before Roaming 926 and associated communications 928, then a BSS transition 930, followed by R-TWT SP Duration after roaming 932 with associated communications 933. The following describes the communications in greater detail.

Operations are being performed, such as seen with trigger frames 940a, 940b sent by AP MLD1, to which STA11 and STA12 of roaming non-AP MLD1, respond with (MU) PPDUs 942a, 942b, which AP MLD1 responds with Acks/(MU) BAs 944a, 944b.

At a certain point within the R-TWT SP before roaming, the roaming non-AP MLD 1 identifies (determines) that it is getting close to the edge (thus it would be expected to leave the BSS soon) of the range of AP MLD 1's BSS.

Then during the SP duration another communication commences between the roaming non-AP MLD1 with STA11 and STA12 and AP11 and AP12 of AP MLD 1. So, this time, in response to trigger frame 946a, roaming non-AP MLD1 transmits an (MU) PPDU 948a indicating an empty frequency slot. During the (MU) PPDU 948a, AP11 of AP MLD1 is shown sending multiple Ack/(MU) BAs 950 that preempt the empty frequency slot with information from AP11.

On link A2, STA12 affiliated with non-AP MLD 1 receives trigger frame 946b, responds with exchanging (MU) PPDU 948b, and receives Ack/(MU) BA 951b from affiliated AP MLD 1.

When STA 11 decides it should initiate BSS transition, a communication takes place 929, in which STA11 sends a CF-End Frame 951a to AP 11 of AP MLD1, indicating that STA11 and STA12 should not transmit (MU) PPDU to AP MLD 1 on link A1 and link A2, as a BSS transition is to take place.

STA 11 processes BSS transition by exchanging FT Request and FT Response frames 952a, 954a with AP11, and (re)association Request and (re)association Response frames 952b, 954b with AP 21 over link A1, the BSS transition is for MLD level, after which roaming non-AP MLD 1 becomes associates with AP MLD 2. It will be noted that on AP22 has a busy medium 956 during this transition, which delays transmission on Link B2.

After roaming non-AP MLD 1 is now within the BSS of AP MLD 2, and a predetermined R-TWT SP 932 for roaming non-AP MLD 1 into AP MLD 2 is utilized. This example also shows the effect of a busy medium 956 on Link B2. After receiving triggers 958a, 958b, STA11 and STA12 transmit trigger based PPDU 960a, 960b from AP21 and AP22 on link B1 and link B2, respectively, and receive Ack/(MU) BA 962a, 962b. AP21 and AP22 stop transmitting trigger frames when the R-TWT SP after Roaming has finished.

It will be seen that the communication on Link A2 proceeds as before, in response to receiving trigger frame 964a, 964b and STA11 and STA12 transmitting (MU) PPDU 966a, 966b, and receiving Ack/(MU (BA) 968a, 968b. It will be noted that the PPDU 966b is constrained in length so as not extend past the duration of the enhanced R-TWT SP duration.

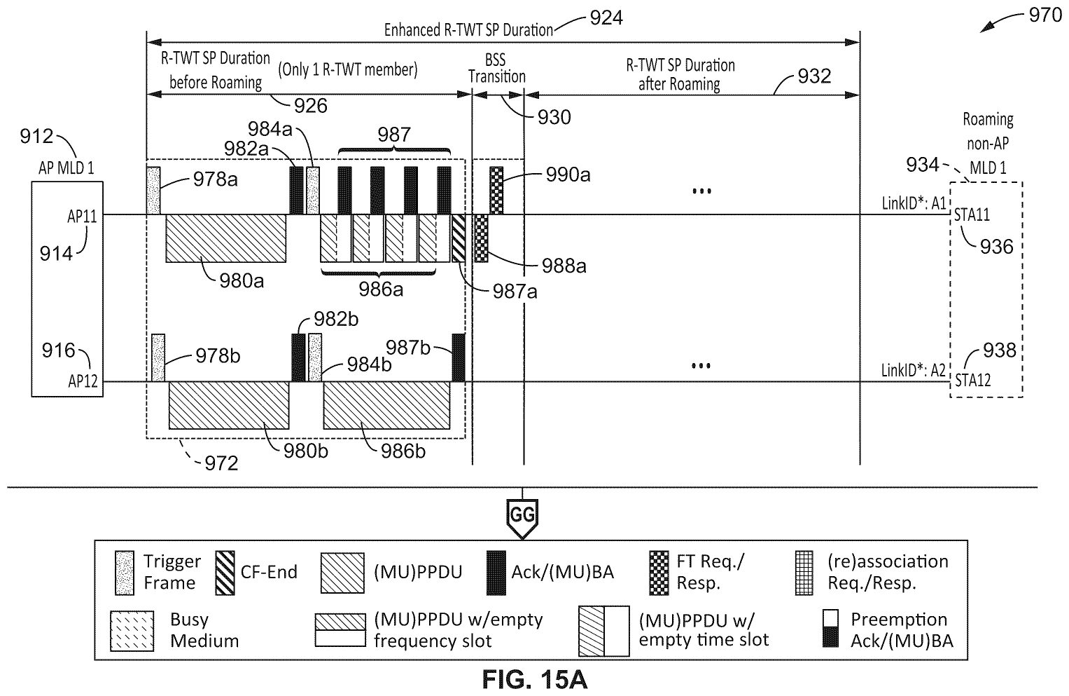

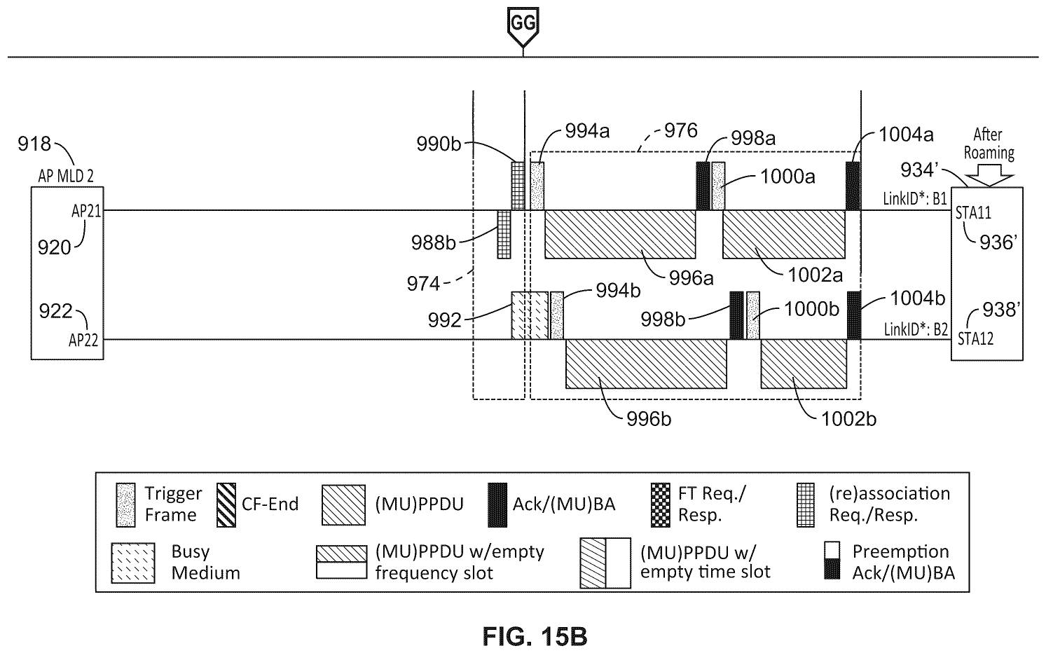

FIG. 15A and FIG. 15B illustrate an example embodiment 950 of MLD level starting and terminating a R-TWT SP for a roaming non-AP MLD before 972 and after 976 roaming with time preemption prior to roaming. This example is based on the topology of non-AP MLD affiliates with a single AP MLD, as shown in FIG. 4.

The figure depicts operations between two BSS, with AP MLD 1 912 shown in FIG. 15A and being in the first BSS, and AP MLD 2 918 shown in FIG. 15B and being in the second BSS. AP MLD 1 912 has two affiliated APs as AP11 914 and AP12 916, and AP MLD 2 918 also has two affiliated APs as AP21 920 and AP22 922. The figure also depicts the APs communicating with the Roaming non-AP MLD 1 934, having STA11 936 and STA12 938, both before 934, and after 934′ roaming.

The roaming non-AP MLD 1 roams from AP MLD 1 in a first BSS to AP MLD 2 in another BSS. Non-AP MLD 1 is within a ongoing trigger-enabled R-TWT SP on link A1 and link A2 when the roaming starts.

In response to trigger frames 978a, 978b, sent by AP11 and AP12, STA11 and STA12 send (MU) PPDUs 980a, 980b, and receive Acks/MU (BAs) 982a, 982b.

At a certain point within the R-TWT SP 924 before roaming 976, the roaming non-AP MLD 1 identifies (determines) that it is getting close to the edge of the BSS for AP MLD 1. We see in the figure that in response to trigger frames 984a, 984b, the roaming non-AP responds as follows.

On link A1, STA 11 affiliated with non-AP MLD 1 exchanges an (MU) PPDUs 986a with empty time slots and receives Ack/(MU) BAs 987 that would preempt the empty time slot with its associated AP11 affiliated with AP MLD 1.

On link A2, STA12 affiliated with non-AP MLD 1 continues the exchange of (MU) PPDU 986b and receives Ack/(MU) BA 987b with its associated AP11 affiliated with AP MLD 1.

When STA 11 decides (determines) it should initiate a BSS transition, it sends a CF-End Frame 987a to AP 11. In response to the CF-End, both STA11 and STA12 should discontinue transmitting (MU) PPDUs to AP MLD 1 on link A1 and link A2.

STA 11 processes a BSS transition 930 by in a communication 974 and exchanges FT Request/Response frames 988a, 990a, and (re)association Request/Response frames 988b. 990b with AP 11 on link A1. By way of example Link B2 is shown busy 992 during the BSS transition time, which does not affect the roaming of the roaming non-AP MLD 1 934. This BSS transition is for the MLD level, after which roaming non-AP MLD 1 becomes associated with AP MLD 2, instead of AP MLD1, and an R-TWT SP Duration after Roaming 932 is entered.

After roaming, non-AP MLD 1 roams to AP MLD 2's BSS, in a predetermined R-TWT SP 976 for roaming non-AP MLD 1 to AP MLD 2. Then in response to trigger frames 994a, 994b, STA11 and STA12 transmit trigger based PPDUs 996a, 996b as the response of receiving trigger frames from AP21 and AP22 on link B1 and link B2, respectively. AP MLD2 responds to the PPDUs with Acks/(MU) BAs 998a, 998b. Then another set of trigger frames 1000a, 1000b, cause STA11 and STA12 to send PPDUs 1002a, 1002b, and Acks/(MU) BAs 1004a, 1004b from AP MLD2. It will be seen that the length of PPDU 1002 may have been shortened so that the communication would still be completed within the Enhanced R-TWT-SP Duration 924. AP21 and AP22 stop transmitting trigger frames when the R-TWT SP has completed.

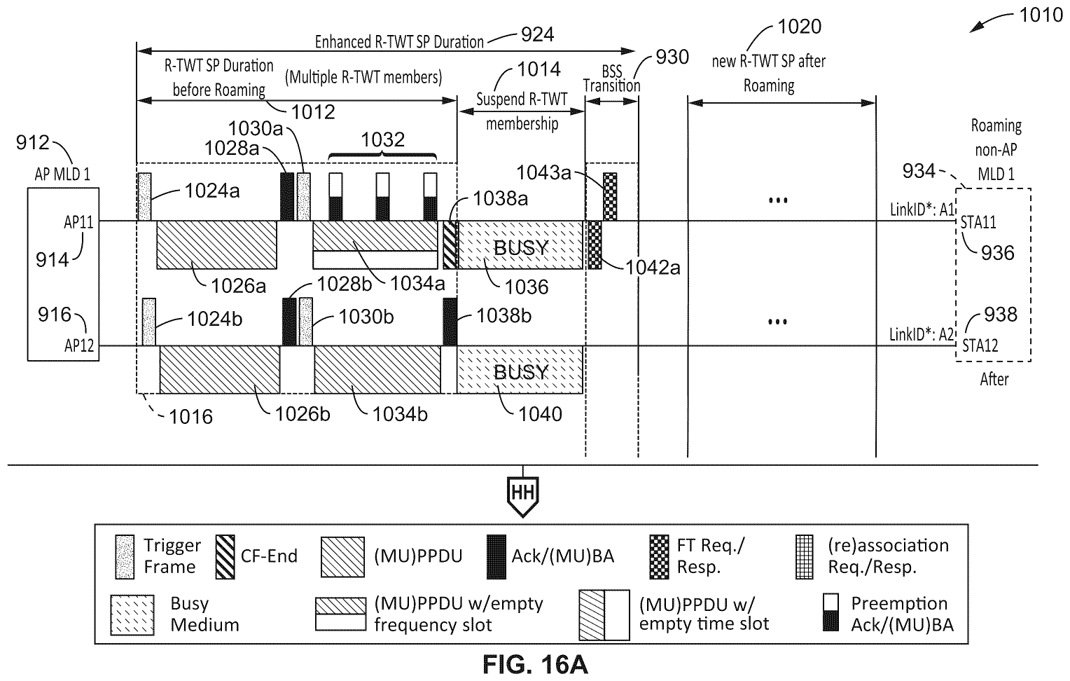

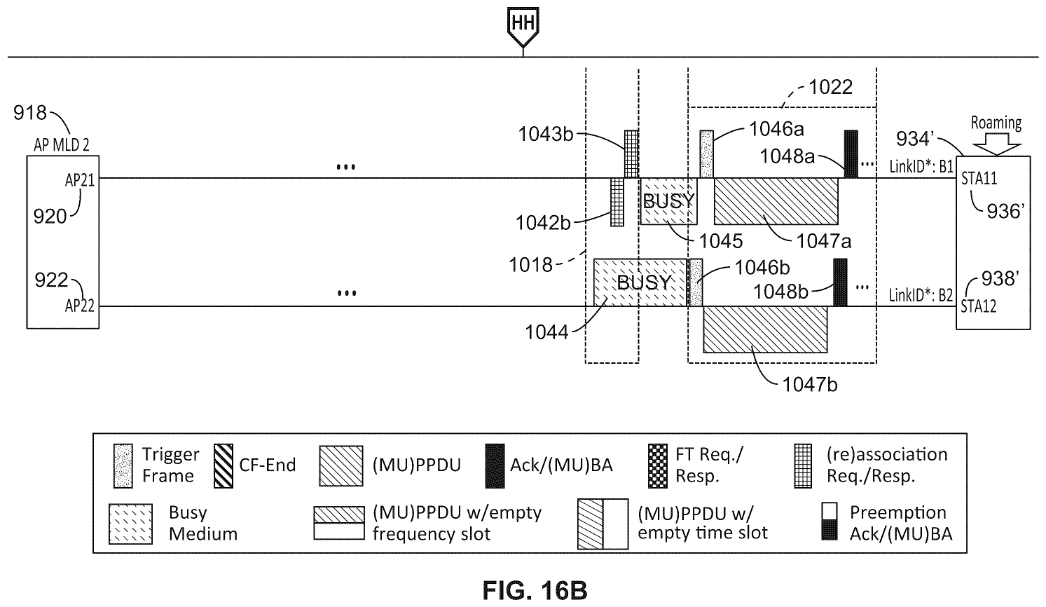

FIG. 16A and FIG. 16B illustrate an example embodiment 1010 of MLD level starting and terminating a R-TWT SP for a roaming non-AP MLD (not the single R-TWT member) before 1016, during 1018 and after roaming 1022 with frequency preemption before roaming.

This example is based on the topology of a non-AP MLD affiliated with a single AP MLD, as shown in FIG. 4. The figure depicts operations between two BSS, with AP MLD 1 912 shown in FIG. 16A and being in the first BSS, and AP MLD 2 918 shown in FIG. 16B and being in the second BSS. AP MLD 1 has two affiliated APs as AP11 914 and AP12 916, and AP MLD 2 also has two affiliated APs as AP21 920 and AP22 922. The figure also depicts the APs communicating with the Roaming non-AP MLD 1, having STA11 936 and STA12 938, both before 934, and after 934′ roaming.

The roaming non-AP MLD 1 roams from AP MLD 1's BSS to AP MLD 2's BSS. Non-AP MLD 1 communication are performed within an ongoing trigger-enabled R-TWT SP 924 on link A1 and link A2 prior to roaming 1012 and when setting up the roaming 1014, 930. This is seen as MLD 1 receiving trigger frames 1024a, 1024b, wherein they each send PPDU(s) 1026a, 1026b, and receive an Acks/(MU) BAs 1028a, 1028b.

Then at a certain point within the R-TWT SP before roaming, the roaming non-AP MLD 1 identifies that it is getting close to the edge of AP MLD 1's BSS, so it starts to set up the roaming. On link A1, upon receiving trigger frame 1030a, STA 11 affiliated with non-AP MLD 1, exchanges an (MU) PPDU 1034a with an empty frequency slot and Ack/(MU) BAs 1032 preempt the empty frequency slot with its associated AP11 affiliated with AP MLD 1. On link A2, STA12 affiliated with non-AP MLD 1 continues, and upon receiving trigger frame 1030b it exchanges (MU) PPDU 1034b and receives an Ack/(MU) BA 1038b from AP11 affiliated with AP MLD 1.

When STA 11 decides it should initiate the BSS transition, it sends CF-End Frame 1038a to AP 11, which suspends the R-TWT memberships 1014, whereby STA11 and STA12 should not transmit (MU) PPDU 1036, 1040 to AP MLD 1 as link A1 and link A2 are busy.

AP11, having received the CF-End Frame, keeps serving other R-TWT members of this R-TWT SP, thus it does not terminate the ongoing R-TWT SP. AP MLD 1 suspends 1014 the R-TWT membership for roaming non-AP MLD 1. STA11 starts a BSS transition 930 when it obtains the channel access during the ongoing R-TWT SP. STA 11 processes the BSS transition by communications 1018 which exchange FT Request/Response frames 1042a, 1043a and (re)association Request/Response frames 1042b, 1043b with AP 11 on link A1, the BSS transition is for the MLD level, after which roaming non-AP MLD 1 becomes associated with AP MLD 2. By way of example, it is seen that Link B2 is busy 1044 during this BSS transition 930, however, this does not impact the roaming of non-AP MLD 1 934.

After roaming non-AP MLD 1 roams to AP MLD 2's BSS, a predetermined R-TWT SP 1020 for roaming non-AP MLD 1 in AP MLD 2 is not started yet and links B1 and B2 have Busy status 1044 and then 1045.

After the predetermined R-TWT SP for roaming the non-AP MLD 1 in the BSS of AP MLD 2 starts (commences), then trigger frames 1046a, 1046b are received in response to which STA11 and STA12 transmit trigger based PPDUs 1047a, 1047b to AP21 and AP22 on link B1 and link B2, respectively, and receive Acks/(MU) BAs 1048a, 1048b. AP21 and AP22 stop transmitting trigger frames when the R-TWT SP after Roaming finished.

10.2. Link Level Term/Start, Non-AP MLD with Multiple AP MLDs

In this section examples are shown of link level termination and starting of an R-TWT SP of roaming non-AP MLD before and after roaming (non-AP MLD affiliated with multiple AP MLD).

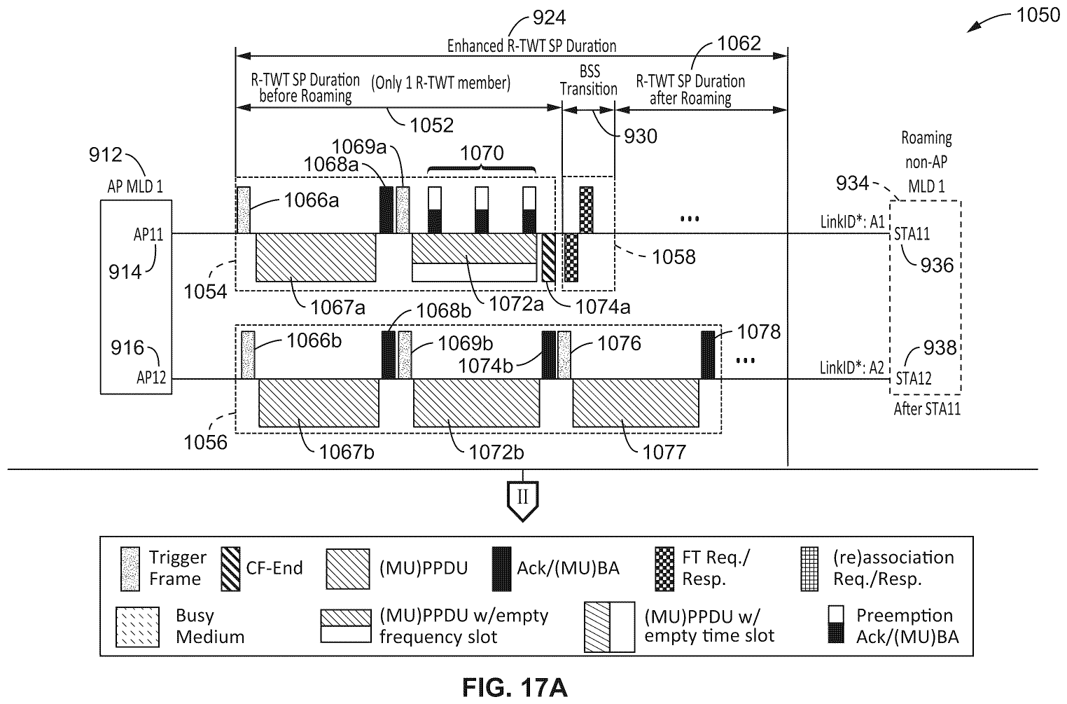

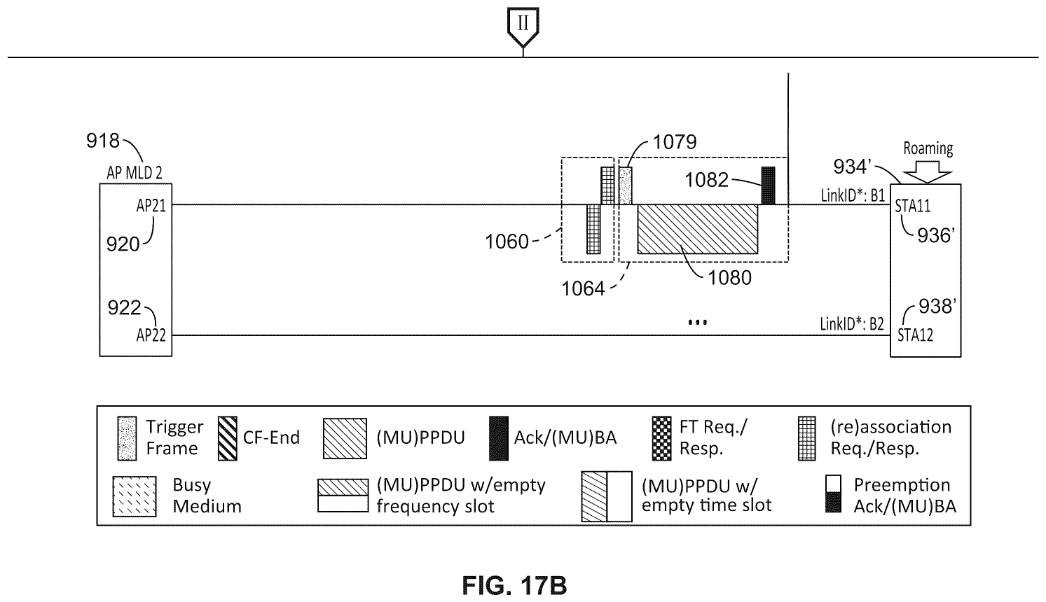

FIG. 17A and FIG. 17B illustrate an example embodiment 1050 of Link level starting and terminating a R-TWT SP 924 for a roaming non-AP MLD (not the single R-TWT member) before 1052, during BSS transition 930, and after roaming 1062 with frequency preemption before roaming. This example is based on the topology of non-AP MLD affiliate with multiple AP MLD, as shown in FIG. 5.

The figure depicts operations between two BSS, with AP MLD 1 912 shown in FIG. 17A and being in the first BSS, and AP MLD 2 918 shown in FIG. 17B and being in the second BSS. AP MLD 1 912 has two affiliated APs as AP11 914 and AP12 916, and AP MLD 2 918 also has two affiliated APs as AP21 920 and AP22 922. The figure also depicts the APs communicating with the Roaming non-AP MLD 1 934, having STA11 936 and STA12 938, both before 934, and after 934′ roaming.

Non-AP MLD 1 communications 1054. 1056, are performed within an ongoing trigger-enabled R-TWT SP 924 on link A1 and link A2 prior to roaming, and when setting up the roaming 930. This is seen as MLD 1 receiving trigger frames 1066a, 1066b, wherein they each send PPDU(s) 1067a, 1067b, and receive Acks/(MU) BAs 1068a, 1068b.

Then at a certain point within the R-TWT SP before roaming, the non-AP MLD1 identifies (determines) that it is getting close to the edge (range) of the BSS for AP MLD 1, and it starts preparing for roaming. At this time, however, non-AP MLD 1 communications are still being performed within an ongoing trigger-enabled R-TWT SP 924 on link A1 and link A2 prior to roaming 1062. This preparation for roaming is seen as non-AP MLD 1 upon receiving trigger frames 1069a, 1069b, sends a regular (MU) PPDU 1072b on Link A2, while a special (MU) PPDU 1072a is sent on Link A1 which has empty frequency slots for use by AP11 914.

On link A2, after (MU) PPDU 1072b, AP MLD1 sends an Ack/(MU) BA 1074b to STA12 in a conventional manner of recognizing communications receipt. However, on link A1, AP MLD 1 912 uses the open frequency slots of the (MU) PPDU 1072a for sending preemptive Ack/(MU) BAs 1070 which contain the acknowledgement information to the roaming non-AP MLD 1. It should be noted that the preemptive Ack just carries the acknowledgement of the received PPDU. The key point is to leave a frequency slot within the reception of long PPDUs so that the roaming STA can receive the preemption Ack in these slots and detect from the RSSI of these received Ack to determine if it is roaming to the edge of the BSS and then let AP know when it needs to perform the BSS Transition.

So, it can be seen in the figure that on link A2, STA12 affiliated with non-AP MLD 1 continues exchanging (MU) PPDU and Ack/(MU) BA with its associated AP11 affiliated with AP MLD 1, exemplified with receiving trigger 1076, sending (MU) PPDU 1077, and receiving Ack/(MU) BA 1078.

During this time, STA 11 has determined it should initiate a BSS transition, whereby it then sends a CF-End frame 1074a to AP 11 of AP MLD 1. In response to this preemption, non-AP MLD 1 discontinues transmitting (MU) PPDUs through STA11 on link A1.

AP11 receiving the CF-End frame 1074a continues serving other R-TWT members of this R-TWT SP, thus it does not terminate the ongoing R-TWT SP 924. AP MLD 1 suspends the R-TWT membership for roaming non-AP MLD 1. STA11 then starts a BSS transition 930 when it obtains channel access during the ongoing R-TWT SP.

STA 11 processes the BSS transition 930 by exchanging FT Request/Response 1058 (Link A1), and (re)association Request/Response frames 1060 (Link A2) with AP 11. The BSS transition is performed at the MLD level, after which roaming non-AP MLD 1 is afterward to be associated with AP MLD 2. It will be noted that only one of the STAs (e.g., here exemplified as the lowest number station) in the non-AP MLD 1 needs to recognize and prepare for the BSS transition.

After roaming, non-AP MLD 1 is then associated with the BSS of AP MLD 2, with a predetermined R-TWT SP 1062 for roaming non-AP MLD 1 in AP MLD 2.

Communication 1064 is then performed as exemplified with a trigger frame 1079 received by STA11 of non-AP MLD 2, which sends a (MU) PPDU 1080, in response to which it receives an Ack/(MU) BA 1082. By way of example the operation performed by STA12 is not shown as being unnecessary. AP21 and AP22 stop transmitting trigger frames when the R-TWT SP is completed after Roaming is completed.

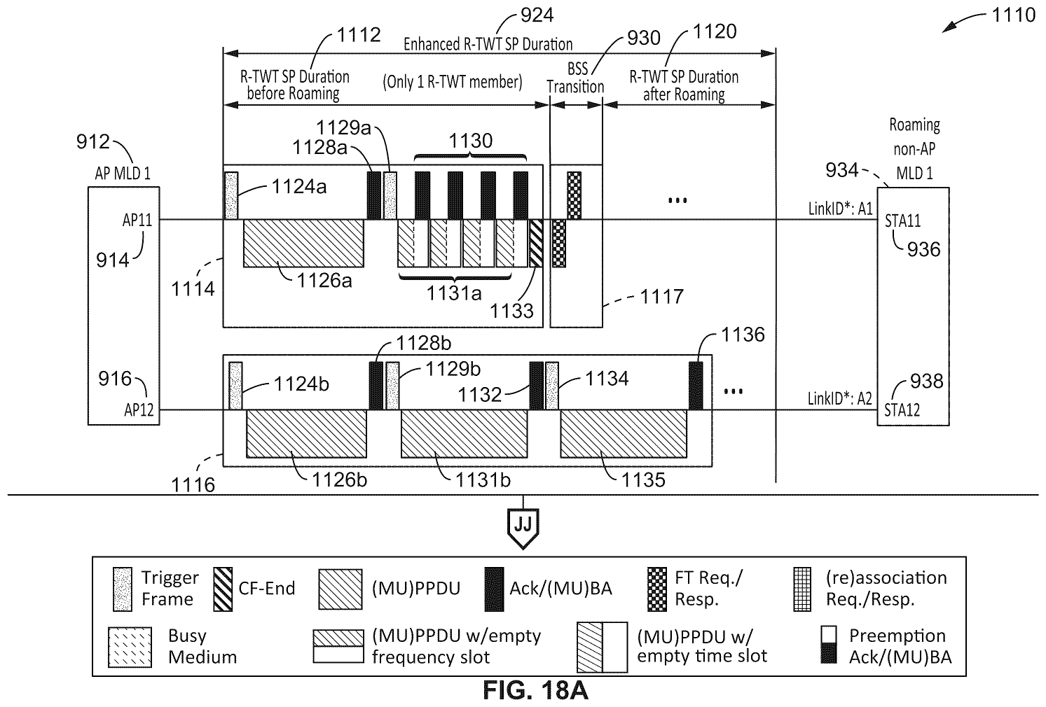

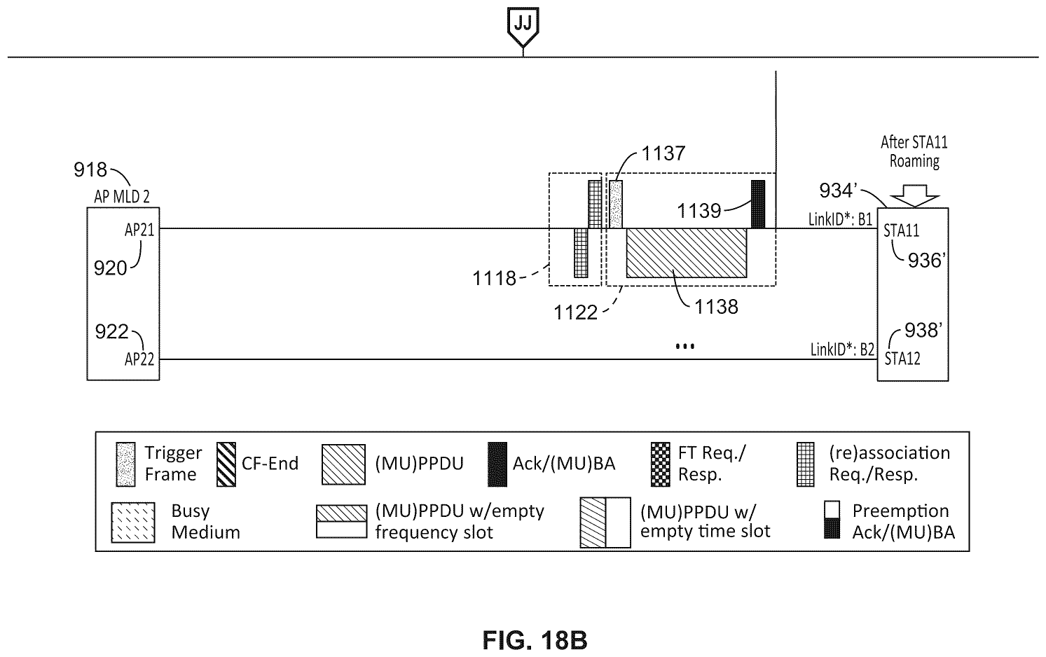

FIG. 18A and FIG. 18B illustrate an example embodiment 1110 of link level starting and terminating a R-TWT SP 924 for a roaming non-AP MLD before 1112, during 930, and after roaming 1120 with time preemption prior to roaming.

This example is based on the topology of non-AP MLD affiliated with multiple AP MLDs, as shown in FIG. 5. In FIG. 18A and FIG. 18B is depicted operations between two BSS, with AP MLD 1 912 shown in FIG. 18A and being in the first BSS, and AP MLD 2 918 shown in FIG. 18B and being in the second BSS. AP MLD 1 has two affiliated APs as AP11 914 and AP12 916, and AP MLD 2 also has two affiliated APs as AP21 920 and AP22 922. The figure also depicts the APs communicating with the roaming non-AP MLD 1 934, having STA11 936 and STA12 938, both before 934, and after 934′ roaming.

The roaming non-AP MLD 1 in this example roams from the BSS of AP MLD 1 to the BSS of AP MLD 2. Non-AP MLD 1 is operating within an ongoing trigger-enabled R-TWT SP 924 on link A1 and link A2 when the roaming commences.

It is seen that communications 1114, 1116 of STA11 and STA12 of non-AP MLD 1 are initially sending (MU) PPDUs 1126a, 1126b in response to receiving trigger frames 1124a, 1124b. AP MLD 1 912 responds to receipt of the PPDUs with Ack/(MU) BAs 1128a, 1128b.

At a certain point within the R-TWT SP 924, non-AP MLD 1 identifies (determines) that it is getting close to the edge (range) of the BSS for AP MLD 1. So toward preparing to make BSS transition 930, STA 11 affiliated with non-AP MLD 1, upon receiving trigger frame 1129a exchanges an (MU) PPDU(s) 1131a which contains empty time slots, thus allowing AP11 affiliated with AP MLD 1 to send Ack/(MU) BAs 1130 to preempt, and thus use, the empty time slots with its associated AP11. The roaming STA can receive the preemption Ack in these time slot and detect from the RSSI of these received Ack to determine if it roaming to the edge of the BSS and then let AP know when that if it needs to do BSS Transition.

During this time period on link A2, STA12 affiliated with non-AP MLD 1 exchanges (MU) PPDU 1131b in response to receiving trigger frame 1129b, and receives Ack/(MU) BA 1132 with its associated AP11 affiliated with AP MLD 1.

When STA 11 decide it should initiate the BSS transition, it sends a CF-End frame 1133 to AP 11. STA11 should not transmit (MU) PPDU to AP MLD 1 on link A1, however, STA12 can keep transmitting trigger-based PPDUs, such as exemplified with receipt of trigger frame 1134, STA12 sending (MU) PPDU 1135, and receiving acknowledgement 1136 with Ack/(MU) BA during the original scheduled R-TWT SP with AP MLD 1.

STA 11 processes the BSS transition 930 by exchanging FT Request/Response 1117 with AP11 on AP MLD1, and (re)association Request/Response frames 1118 with AP 21 on AP MLD 2, with the BSS transition being performed at the link level, after which STA11 is now affiliated with roaming non-AP MLD 2 and R-TWT duration after roaming 1120 takes place allowing STA12 to complete 1122 its transmissions with AP MLD 1, exemplified with STA11 receiving trigger frame 1137, sending (MU) PPDU 1138, and receiving an Ack/(MU) BA 1139.

Thus, after R-TWT SP 924, STA11 is now associated with AP21 affiliated with AP MLD 2, and a R-TWT SP 1120 for roaming non-AP MLD 1 in AP MLD 2 on link B1 is performed. In response to receiving a trigger frame 1137 from AP21 of AP MLD 2, STA11 transmits trigger-based PPDU 1138, and receives an Ack/(MU) BA 1139. And then roaming non-AP MLD 1, including both STA11, and STA12 of non-AP MLD 1 are connected to AP21 and AP22 of AP MLD 2 on links B1 and B2.

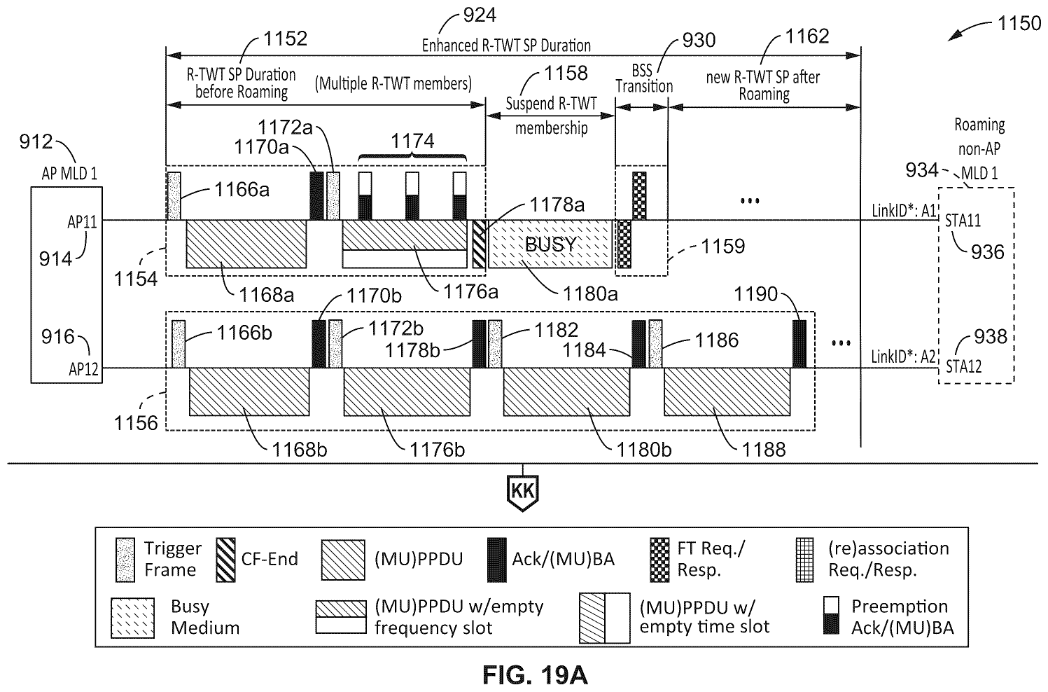

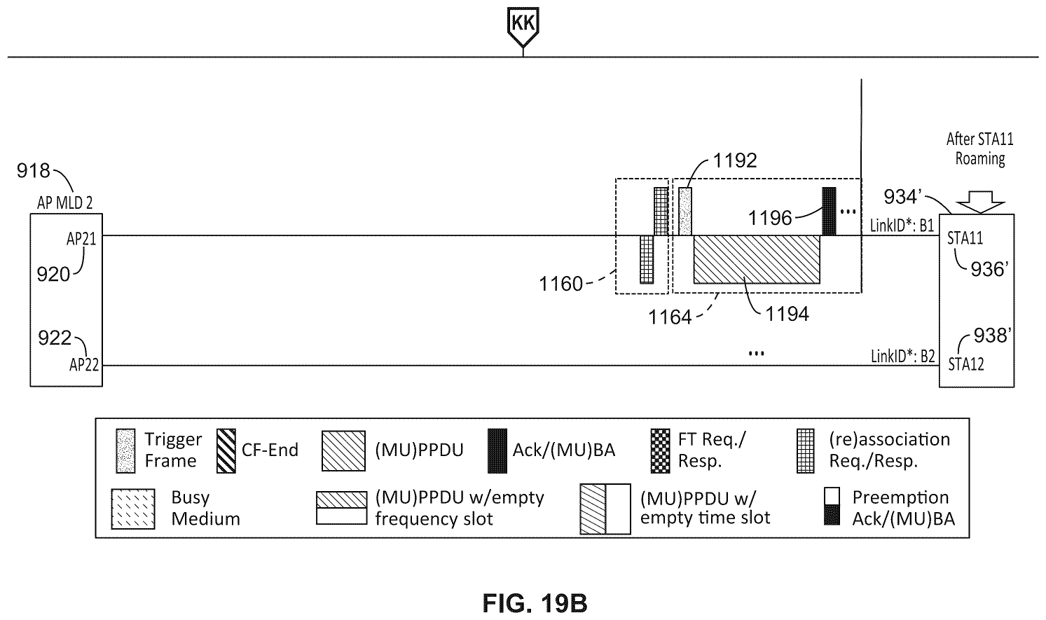

FIG. 19A and FIG. 19B illustrate an example embodiment 1150 of Link level starting and terminating a R-TWT SP of a roaming non-AP MLD (not the single R-TWT member) before 1152, during 1158, 930, and after 1162 roaming with frequency preemption before roaming.

This example is based on the topology of non-AP MLD affiliate with multiple AP MLDs, as shown in FIG. 5. The figure depicts operations between two BSS, with a first BSS having AP MLD 1 912 shown in FIG. 19A, and as second BSS having AP MLD 2 918 shown in FIG. 19B. AP MLD 1 has two affiliated APs as AP11 914 and AP12 916, and AP MLD 2 also has two affiliated APs as AP21 920 and AP22 922. The figure also depicts the APs communicating with the roaming non-AP MLD 1, having STA11 936 and STA12 938, both before 934, and after 934′ roaming.

The roaming non-AP MLD 1 roams from the BSS of AP MLD 1 912 to the BSS of AP MLD 2 918. Non-AP MLD 1 is within an ongoing trigger-enabled R-TWT SP 924 on link A1 and link A2 when roaming starts.

It is seen that STA11 and STA12 of non-AP MLD 1 are initially sending (MU) PPDUs 1168a, 1168b in response to receiving trigger frames 1166a, 1166b. AP MLD 1 responds to receipt of the PPDUs with Ack/(MU) BAs 1170a, 1170b.

At a certain point within the R-TWT SP 924 the roaming non-AP MLD 1 identifies (determines) that it is getting close to the edge (range) of the BSS for AP MLD 1. So, in response to trigger frame 1172a, STA 11 affiliated with non-AP MLD 1 exchanges (sends) a (MU) PPDU 1176a with an empty frequency slot on link A1, to which AP11 of AP MLD 1 preempts with preemptive Ack/(MU) BA 1174 which preempts the empty frequency slots. The roaming STA can receive the preemption Ack in these frequency slot and detect from the RSSI of these received Ack to determine if it roaming to the edge of the BSS and then let AP know when that if it needs to do BSS Transition.

On link A2, STA12 affiliated with non-AP MLD 1 continues its communication 1156, and upon receiving trigger frame 1172b, exchanges an (MU) PPDU 1176b and receives an Ack/(MU) BA 1178b from its associated AP11 affiliated with AP MLD 1.

When STA 11 decides (determines) it should initiate the suspension 1158 and BSS transition 930, it sends a CF-End frame 1178a to AP 11, which starts a suspension 1158 of R-TWT membership. STA11 should not transmit (MU) PPDU to AP MLD 1 on link A1 which is thus considered busy 1180a.

STA12, however, can continue to transmit trigger-based PPDUs on link A2 during the original scheduled R-TWT SP with AP MLD 1. By way of example STA12 is shown receiving a trigger frame 1182 and transmitting PPDU 1180b, for which it then receives an Ack/(MU) BA 1184 from AP12; then it is seen receiving a trigger frame 1186 and transmitting PPDU 1188, for which it then receives an Ack/(MU) BA 1190 from AP12.

AP11 upon receiving CF-End frame 1178a continues serving other R-TWT members of this R-TWT SP, thus it does not terminate the ongoing R-TWT SP 924, although AP MLD 1 has suspended R-TWT membership for STA11.

STA11 starts a BSS transition when it obtains channel access during a BSS transition 930 in the ongoing R-TWT SP 924. STA 11 processes the BSS transition by exchanging FT Request/Response frames 1159 with AP11 of AP MLD 1, and (re)association Request/Response frames 1160 with AP 21 of AP MLD 2. The BSS transition is performed here at a link level, after which STA11 is associated with AP21 of AP MLD 2, while STA12 is still associated with AP11 of AP MLD 1.

After STA11 roams to the BSS of AP21, a predetermined R-TWT SP 1162 allows communication 1164 for roaming non-AP MLD 1 with AP MLD 2 on link B1 in which, STA11 on receiving a trigger frame 1192, transmits PPDU 1194, and receives Ack/(MU) BA 1196 from AP21 on link B1. AP21 stops transmitting trigger frames when R-TWT SP roaming has been completed. Nothing is shown for traffic on Link B2 as STA12 is still associated with AP MLD 1.

### 11. Brief Summary of Disclosed Protocol Elements

A brief summary is provided below of selected aspects/elements of the present disclosure, provided by way of example and not of limitation.
(1) When a roaming non-AP MLD, which is in the process of transmitting/receiving latency sensitive traffic during a R-TWT SP, is roaming from the BSS of its original associated AP MLD to the BSS of its target AP MLD, it can use a predetermined/enhanced R-TWT SP accepted by the target AP MLD without further negotiation for an R-TWT SP after roaming.
(2) The roaming non-AP MLD (as mentioned in aspect 1) could set up the enhanced R-TWT SP at roaming AP MLD level or at AP MLD level, both processes should be finished before roaming is finished.
(3) In the case of scheduling an enhanced R-TWT SP for roaming at the AP MLD level (as mentioned in aspect (2)), then either a universal enhanced R-TWT SP, or non-universal enhanced R-TWT SP with multiple R-TWT SPs corresponding to different AP MLD of the roaming AP MLD, can be scheduled.
(4) In the case of scheduling an enhanced R-TWT SP at the AP MLD level (as mentioned in aspect (2)), the non-AP MLD can negotiate an enhanced R-TWT with the target AP MLD, through relaying of its associated AP MLD and the Roaming AP MLD, which in at least one embodiment can be processed by: (a) allowing the current associated AP MLD to negotiate an enhanced R-TWT schedule with the non-AP MLD on behalf of the target AP MLD before roaming; or (b) allowing the current associated AP MLD to negotiate an enhanced R-TWT schedule with the non-AP MLD on behalf of the target AP MLD along with the exchange of FT Request and FT Response Frames during roaming; or (c) allowing the non-AP MLD to directly negotiate the enhanced R-TWT schedule with the target AP MLD through the exchange of (re)association Request and (re)association Response Frames that carry the enhanced R-TWT element at the end of roaming.
(5) To achieve the enhanced R-TWT SP setup (as mentioned in aspect (1)), a new TID-to-Global-Link Mapping is configured to indicate the links, identified by global link IDs, on which frames belonging to each TID can be exchanged by any of the following. (a) The Roaming non-AP MLD, Roaming AP MLD and the affiliated AP MLDs of the Roaming AP MLD can support the TID-to-Global-Link Mapping (TTGLM) negotiation, which can be processed during ML (re) setup. (b) A new TTGLM element can be configured to indicate the links, which are identified by global link IDs, on which frames belonging to each TID can be exchanged. (c) The Roaming non-AP MLD can negotiate the TTGLM with the Roaming AP MLD through the relay of its associated AP MLD. (d) The TTGLM negotiation of the TID-to-Global-Link Mapping can be processed with an exchange of TID-To-Global-Link Mapping Request frame and TID-To-Global-Link Mapping Response frame that carries the TID-to-Global-Link Mapping element. (e) The TTGLM negotiation can also be processed by exchanging (re) Association Request frame and (re) Association Response frames that carries the TID-to-Global-Link Mapping element.
(6) The present disclosure provides a new enhanced R-TWT termination rules when the roaming non-AP MLD (as mentioned in aspect (1)) is moving close to, or across, the edge of the original associated AP MLD: (a) In the case of roaming a non-AP MLD associated with a single serving AP MLD: (a) (i) The roaming non-AP MLD should have at least one link for exchanging (MU) PPDUs with an empty frequency or time slot and using Ack/(MU) BA that preempts the empty frequency or time slot to monitor the frames from its associated AP MLD to decide if it should stop transmission within the ongoing R-TWT SP. (a) (ii) The roaming non-AP MLD can send a frame to its associated AP MLD to indicate it no longer needs to be served by the ongoing R-TWT SP. The AP MLD receives this frame that is addressed to it, and should terminate the current R-TWT SP, unless there are other R-TWT members of this R-TWT SP using this R-TWT SP, in which case the AP MLD should maintain the R-TWT SP for other R-TWT members and suspend the R-TWT membership of the roaming non-AP MLD. (b) In the case of a roaming non-AP MLD associated with several serving AP MLD, the roaming non-AP MLD is to have at least one link to maintain the association with the original AP MLD and the original R-TWT schedule on that link(s). On the remaining link(s), the roaming non-AP MLD should follow the same rule (as mentioned in aspect (6) (a)).
(7) The present disclosure provides new enhanced R-TWT resume/restart rules for when the roaming non-AP MLD (as mentioned in aspect (1)) finishes its transition to the BSS of the roaming target AP MLD:
(7) (a) In the case of a roaming non-AP MLD associated with a single serving AP MLD: (a) (i) when there is no ongoing R-TWT SP in the new BSS, the AP MLD of the new BSS and/or the roaming non-AP MLD should resume or restart the R-TWT SP based on the predetermined enhanced R-TWT schedule, without requiring further negotiation. (a) (i) (1) In the case of an enhanced R-TWT SP scheduled for the roaming non-AP MLD in the target BSS which hasn't yet started; the AP MLD of the new BSS can apply UORA to trigger the roaming non-AP MLD to provide random access. (a) (ii) When there is an existing ongoing R-TWT SP in the new BSS, which is not the same as the predetermined R-TWT SP for the roaming non-AP MLD, the target AP can grant the roaming non-AP MLD a temporary membership of the ongoing R-TWT SP. (a) (iii) When there is an existing ongoing R-TWT SP in the new BSS, which is the same as the predetermined R-TWT SP for the roaming non-AP MLD, the target AP MLD should trigger the roaming non-AP MLD as the member and the roaming non-AP MLD should access the medium during the R-TWT SP with the R-TWT member priority.
(7) (b) In the case of a roaming non-AP MLD associated with several serving AP MLDs, the roaming non-AP MLD should have at least one link to maintain the association with the original AP MLD and the original R-TWT schedule on that link(s). On the remaining link(s), the roaming non-AP MLD should follow the same rule (as mentioned in aspect (7) (a)).
(8) The roaming STA affiliated with a roaming non-AP MLD can determiner (identify) if it has moved close to the edge (as mentioned in aspect (6)) of the associated AP MLD based on several criteria, which include but are not limited by: (a) the throughput and/or packet loss rate of its transmission; (b) the RSSI of the received Ack/(MU) BA as the response of its transmitted (MU) PPDU; (c) the RSSI of the received preemption Ack/(MU) BA as the response of its transmitted (MU) PPDU with empty frequency or time slot(s) for preemption; (d) the detection of OBSS signals, in terms of the RSSI of the OBSS signal, the frequency of the detection of OBSS signals, and so forth; (e) the roaming signal from the co-located STA which affiliated with the same roaming non-AP MLD.

### 12. General Scope of Embodiments

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A multiple station apparatus for communication in a wireless network, the apparatus comprising: (a) a multiple link device (MLD) having at least two stations, in which each station has at least one modem coupled to at least one radio-frequency (RF) circuit, with each RF circuit connected to one or multiple antennas; (b) a processor of said MLD; (c) a non-transitory memory storing instructions executable by the processor for wirelessly communicating with other stations on a IEEE 802.11 wireless local area network (WLAN); and (d) wherein said instructions, when executed by the processor, perform steps of a wireless communications protocol, comprising: (d) (i) wherein said MLD operates a wireless communications protocol as either an access point (AP) MLD or a non-AP MLD; (d) (ii) wherein when said MLD is operating as a non-AP MLD, it is configured for transmitting and/or receiving latency sensitive traffic during a R-TWT SP in a first basic service set (BSS); (d) (iii) wherein said MLD is configured to allow roaming from this first BSS of an original AP MLD to which it is associated, to a second BSS of a target AP MLD; (d) (iv) wherein the roaming non-AP MLD, or one or more station links within the roaming non-AP MLD, negotiates to use a predetermined and/or enhanced R-TWT SP of the target AP MLD, whereby after roaming the non-AP MLD, or one or more station links within the roaming non-AP MLD, can immediately communicate in the R-TWT SP of the target AP MLD without further negotiation; (d) (v) wherein when said MLD is operating as an AP MLD, it can contain MLD common functions in the MLD upper MAC sublayer and contain per-link functions in MLD lower MAC sublayer; and (d) (vi) wherein when said MLD is operating as an AP MLD, it connects its lower MAC sublayer with the roaming AP MLD upper layer through a backhaul connection with a roaming AP MLD, which functions as a central controller; wherein the TID-to-Link mapping and the link merging functions are carried in the MLD common functions in the AP MLD upper MAC or in the roaming AP MLD upper MAC.

A multiple station apparatus for communication in a wireless network, the apparatus comprising: (a) a multiple link device (MLD) having at least two stations, in which each station has at least one modem coupled to at least one radio-frequency (RF) circuit, with each RF circuit connected to one or multiple antennas; (b) a processor of said MLD; (c) a non-transitory memory storing instructions executable by the processor for wirelessly communicating with other stations on a IEEE 802.11 wireless local area network (WLAN); and (d) wherein said instructions, when executed by the processor, perform steps of a wireless communications protocol, comprising: (d) (i) wherein said MLD operates a wireless communications protocol as either an access point (AP) MLD or a non-AP MLD; (d) (ii) wherein when said MLD is operating as a non-AP MLD, it is configured for transmitting and/or receiving latency sensitive traffic during a R-TWT SP in a first BSS; (d) (iii) wherein said MLD is configured to allow roaming from this first BSS of an original AP MLD to which it is associated, to a second BSS of a target AP MLD; (d) (iv) wherein the roaming non-AP MLD, or one or more station links within the roaming non-AP MLD, negotiates to use a predetermined and/or enhanced R-TWT SP of the target AP MLD, whereby after roaming the non-AP MLD, or one or more station links within the roaming non-AP MLD, can immediately communicate in the R-TWT SP of the target AP MLD without further negotiation; (d) (v) wherein when said MLD is operating as an AP MLD, it can contain MLD common functions in the MLD upper MAC sublayer and contain per-link functions in MLD lower MAC sublayer; (d) (vi) wherein when said MLD is operating as an AP MLD, it connects its lower MAC sublayer with the roaming AP MLD upper layer through a backhaul connection with a roaming AP MLD, which functions as a central controller; wherein the TID-to-Link mapping and the link merging functions are carried in the MLD common functions in the AP MLD upper MAC or in the roaming AP MLD upper MAC; and (d) (vii) wherein the roaming non-AP MLD can setup an enhanced R-TWT SP at a roaming AP MLD level or at an AP MLD link level, either of which are to be completed before roaming is finished. and wherein in scheduling an enhanced R-TWT SP for roaming at the AP MLD level, then either a universal enhanced R-TWT SP, or non-universal enhanced R-TWT SP with multiple R-TWT SPs corresponding to different AP MLD of the roaming AP MLD, can be scheduled.

A method of communicating in a wireless network with a multiple link device, the comprising: (a) communicating in a wireless network in which at least one multiple link device (MLD) with at least two stations with each station having at least one modem coupled to at least one radio-frequency (RF) circuit, with each RF circuit connected to one or multiple antennas; (b) operating said MLD in a wireless communications protocol as either an access point (AP) MLD or a non-AP MLD; (c) wherein when said MLD is operating as a non-AP MLD, it is configured for transmitting and/or receiving latency sensitive traffic during a R-TWT SP in a first basic service set (BSS); (d) wherein said MLD is configured to allow roaming from this first BSS of an original AP MLD to which it is associated, to a second BSS of a target AP MLD; (e) wherein the roaming non-AP MLD, or one or more station links within the roaming non-AP MLD, negotiates to use a predetermined and/or enhanced R-TWT SP of the target AP MLD, whereby after roaming the non-AP MLD, or one or more station links within the roaming non-AP MLD, can immediately communicate in the R-TWT SP of the target AP MLD without further negotiation; (f) wherein when said MLD is operating as an AP MLD, it can contain MLD common functions in the MLD upper MAC sublayer and contain per-link functions in MLD lower MAC sublayer; and (g) wherein when said MLD is operating as an AP MLD, it connects its lower MAC sublayer with the roaming AP MLD upper layer through a backhaul connection with a roaming AP MLD, which is a function as a central controller; wherein the TID-to-Link mapping and the link merging functions are carried in the MLD common functions in the AP MLD upper MAC or in the roaming AP MLD upper MAC.

The apparatus or method of any preceding implementation, wherein when a roaming non-AP MLD, which is in process of transmitting or receiving latency sensitive traffic during a R-TWT SP, is roaming from the BSS of its original associated AP MLD to the BSS of its target AP MLD, it can use a predetermined or enhanced R-TWT SP accepted by the target AP MLD, without further negotiation for an R-TWT SP after roaming.

The apparatus or method of any preceding implementation, wherein the roaming non-AP MLD can set up an enhanced R-TWT SP at a roaming AP MLD level or at an AP MLD link level, either of which are to be completed before roaming is finished.

The apparatus or method of any preceding implementation, wherein in scheduling an enhanced R-TWT SP for roaming at the AP MLD level, then either a universal enhanced R-TWT SP, or non-universal enhanced R-TWT SP with multiple R-TWT SPs corresponding to different AP MLD of the roaming AP MLD, can be scheduled.

The apparatus or method of any preceding implementation, wherein in scheduling an enhanced R-TWT SP at the AP MLD level, the non-AP MLD can negotiate an enhanced R-TWT with the target AP MLD, through relaying of its associated AP MLD and the roaming AP MLD, comprising: (a) allowing the current associated AP MLD to negotiate an enhanced R-TWT schedule with the non-AP MLD on behalf of the target AP MLD before roaming; or (b) allowing the current associated AP MLD to negotiate an enhanced R-TWT schedule with the non-AP MLD on behalf of the target AP MLD along with the exchange of fast BSS transition (FT) request and FT response frames during roaming; or (c) allowing the non-AP MLD to directly negotiate the enhanced R-TWT schedule with the target AP MLD through the exchange of (re)association request and (re)association response frames that carry the enhanced R-TWT element at the end of roaming.

The apparatus or method of any preceding implementation, wherein in achieving an enhanced R-TWT SP setup, a new TID-to-Global-Link mapping is configured to indicate the links, identified by global link identifiers, on which frames belonging to each traffic identifier (TID) can be exchanged by any of the following, comprising: (a) supporting the TID-to-Global-Link Mapping (TTGLM) negotiation, which can be processed during multilink (ML) setup or re-setup by the roaming non-AP MLD, or by the roaming AP MLD and the affiliated AP MLDs of the roaming AP MLD; or (b) utilizing a new TTGLM element which is configured to indicate the links, which are identified by global link identifiers (IDs), on which frames belonging to each traffic identifier (TID) can be exchanged; or (c) negotiating the TTGLM, by the roaming non-AP MLD, with the roaming AP MLD through the relay of its associated AP MLD; or (d) performing TTGLM negotiation of the TID-to-Global-Link Mapping with an exchange of TID-To-Global-Link Mapping Request frame and TID-To-Global-Link Mapping Response frame that carries the TID-to-Global-Link Mapping element; or (e) performing TTGLM negotiation by exchanging an association request frame, or reassociation request frame, and association response frames or reassociation response frames that carry the TID-to-Global-Link Mapping element.

The apparatus or method of any preceding implementation, wherein the apparatus provides new enhanced R-TWT termination rules when the roaming non-AP MLD is moving close to, or across, the edge of the original associated AP MLD, and performs steps comprising: (a) performing steps, in the case of roaming a non-AP MLD associated with a single serving AP MLD, comprising: (a) (i) requiring the roaming non-AP MLD to have at least one link for exchanging multi-user (MU) physical-layer protocol data units (PPDUs) with an empty frequency or time slot and using acknowledgements (Acks) or multi-user (MU) block acknowledgements (BA) that preempts the empty frequency or time slot to monitor the frames from its associated AP MLD to determine if it should stop transmission within the ongoing R-TWT SP; (a) (ii) allowing the roaming non-AP MLD to send a frame to its associated AP MLD to indicate it no longer needs to be served by the ongoing R-TWT SP; wherein the AP MLD receives this frame that is addressed to it, and terminates the current R-TWT SP, unless there are other R-TWT members of this R-TWT SP using this R-TWT SP, in which case the AP MLD maintains the R-TWT SP for other R-TWT members and suspends the R-TWT membership of the roaming non-AP MLD; and (b) requiring, in the case of a roaming non-AP MLD associated with several serving AP MLD, the roaming non-AP MLD to have at least one link to maintain the association with the original AP MLD and the original R-TWT schedule on that link, or links, while on the remaining link, or links, the roaming non-AP MLD follows the same rule as in step (a).

The apparatus or method of any preceding implementation, wherein the apparatus provides new enhanced R-TWT resume or restart rules for when the roaming non-AP MLD finishes its transition to the BSS of the roaming target AP MLD, and performs steps comprising: (a) performing steps in the case of a roaming non-AP MLD associated with a single serving AP MLD, comprising: (a) (i) resuming or restarting the R-TWT SP based on the predetermined enhanced R-TWT schedule without requiring further negotiation, when there is no ongoing R-TWT SP in the new BSS, the AP MLD of the new BSS and/or the roaming non-AP MLD; and wherein in case of an enhanced R-TWT SP scheduled for the roaming non-AP MLD in the target BSS which hasn't yet started, the AP MLD of the new BSS applies UL orthogonal frequency domain multiple access (OFDMA)-based random access (UORA) to trigger the roaming non-AP MLD to provide random access; (a) (ii) granting the roaming non-AP MLD a temporary membership of the ongoing R-TWT SP, by the target AP, when there is an existing ongoing R-TWT SP in the new BSS, which is not the same as the predetermined R-TWT SP for the roaming non-AP MLD; (a) (iii) triggering the roaming non-AP MLD, by the target AP MLD, as the member and the roaming non-AP MLD should access the medium during the R-TWT SP with the R-TWT member priority, when there is an existing ongoing R-TWT SP in the new BSS, which is the same as the predetermined R-TWT SP for the roaming non-AP MLD; (b) assuring that the roaming non-AP MLD has at least one link to maintain the association with the original AP MLD and the original R-TWT schedule on that link, when a roaming non-AP MLD is associated with several serving AP MLDs; while on the remaining link, or links, the roaming non-AP MLD should follow step (a).

The apparatus or method of any preceding implementation, wherein the roaming STA affiliated with a roaming non-AP MLD determines or identifies if it has moved close to the edge of the associated AP MLD based on criteria selected from the group of selection criterion, consisting of: (a) throughput and/or packet loss rate of its transmission; (b) received signal strength indicator (RSSI) of the received acknowledgement or multiple-user (MU) block acknowledgement (BA) as the response of its transmitted multi-user (MU) physical-layer protocol data unit (PPDU); (c) RSSI of the received preemption acknowledgement or multiple-user (MU) block acknowledgement (BA) as the response of its transmitted (MU) PPDU with empty frequency or time slot(s) for preemption; (d) detection of OBSS signals, in terms of the RSSI of the overlapping BSS (OBSS) signal, and the frequency of the detection of OBSS signals; and (e) roaming signals from the co-located station which is affiliated with the same roaming non-AP MLD.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A multiple station apparatus for communication in a wireless network, the apparatus comprising:
(a) a multiple link device (MLD) having at least two stations, in which each station has at least one modem coupled to at least one radio-frequency (RF) circuit, with each RF circuit connected to one or multiple antennas;
(b) a processor of said MLD;
(c) a non-transitory memory storing instructions executable by the processor for wirelessly communicating with other stations on a IEEE 802.11 wireless local area network (WLAN); and
(d) wherein said instructions, when executed by the processor, perform steps of a wireless communications protocol, comprising:
(i) wherein said MLD operates a wireless communications protocol as either an access point (AP) MLD or a non-AP MLD;
(ii) wherein when said MLD is operating as a non-AP MLD, it is configured for transmitting and/or receiving latency sensitive traffic during a R-TWT SP in a first basic service set (BSS);
(iii) wherein said MLD is configured to allow roaming from this first BSS of an original AP MLD to which it is associated, to a second BSS of a target AP MLD;
(iv) wherein the roaming non-AP MLD, or one or more station links within the roaming non-AP MLD, negotiates to use a predetermined and/or enhanced R-TWT SP of the target AP MLD, whereby after roaming the non-AP MLD, or one or more station links within the roaming non-AP MLD, can immediately communicate in the R-TWT SP of the target AP MLD without further negotiation;
(v) wherein when said MLD is operating as an AP MLD, it can contain MLD common functions in the MLD upper MAC sublayer and contain per-link functions in MLD lower MAC sublayer; and
(vi) wherein when said MLD is operating as an AP MLD, it connects its lower MAC sublayer with the roaming AP MLD upper layer through a backhaul connection with a roaming AP MLD, which functions as a central controller; wherein the TID-to-Link mapping and the link merging functions are carried in the MLD common functions in the AP MLD upper MAC or in the roaming AP MLD upper MAC.

2. The apparatus of claim 1, wherein when a roaming non-AP MLD, which is in process of transmitting or receiving latency sensitive traffic during a R-TWT SP, is roaming from the BSS of its original associated AP MLD to the BSS of its target AP MLD, it can use a predetermined or enhanced R-TWT SP accepted by the target AP MLD, without further negotiation for an R-TWT SP after roaming.

3. The apparatus of claim 1, wherein the roaming non-AP MLD can set up an enhanced R-TWT SP at a roaming AP MLD level or at an AP MLD link level, either of which are to be completed before roaming is finished.

4. The apparatus of claim 3, wherein in scheduling an enhanced R-TWT SP for roaming at the AP MLD level, then either a universal enhanced R-TWT SP, or non-universal enhanced R-TWT SP with multiple R-TWT SPs corresponding to different AP MLD of the roaming AP MLD, can be scheduled.

5. The apparatus of claim 3, wherein in scheduling an enhanced R-TWT SP at the AP MLD level, the non-AP MLD can negotiate an enhanced R-TWT with the target AP MLD, through relaying of its associated AP MLD and the roaming AP MLD, comprising:
(a) allowing the current associated AP MLD to negotiate an enhanced R-TWT schedule with the non-AP MLD on behalf of the target AP MLD before roaming; or
(b) allowing the current associated AP MLD to negotiate an enhanced R-TWT schedule with the non-AP MLD on behalf of the target AP MLD along with the exchange of fast BSS transition (FT) request and FT response frames during roaming; or
(c) allowing the non-AP MLD to directly negotiate the enhanced R-TWT schedule with the target AP MLD through the exchange of (re)association request and (re)association response frames that carry the enhanced R-TWT element at the end of roaming.

6. The apparatus of claim 1, wherein in achieving an enhanced R-TWT SP setup, a new TID-to-Global-Link mapping is configured to indicate the links, identified by global link identifiers, on which frames belonging to each traffic identifier (TID) can be exchanged by any of the following, comprising:
(a) supporting the TID-to-Global-Link Mapping (TTGLM) negotiation, which can be processed during multilink (ML) setup or re-setup by the roaming non-AP MLD, or by the roaming AP MLD and the affiliated AP MLDs of the roaming AP MLD; or
(b) utilizing a new TTGLM element which is configured to indicate the links, which are identified by global link identifiers (IDs), on which frames belonging to each traffic identifier (TID) can be exchanged; or
(c) negotiating the TTGLM, by the roaming non-AP MLD, with the roaming AP MLD through the relay of its associated AP MLD; or
(d) performing TTGLM negotiation of the TID-to-Global-Link Mapping with an exchange of TID-To-Global-Link Mapping Request frame and TID-To-Global-Link Mapping Response frame that carries the TID-to-Global-Link Mapping element; or
(e) performing TTGLM negotiation by exchanging an association request frame, or reassociation request frame, and association response frames or reassociation response frames that carry the TID-to-Global-Link Mapping element.

7. The apparatus of claim 1, wherein the apparatus provides new enhanced R-TWT termination rules when the roaming non-AP MLD is moving close to, or across, the edge of the original associated AP MLD, and performs steps comprising:
(a) performing steps, in the case of roaming a non-AP MLD associated with a single serving AP MLD, comprising:
(i) requiring the roaming non-AP MLD to have at least one link for exchanging multi-user (MU) physical-layer protocol data units (PPDUs) with an empty frequency or time slot and using acknowledgements (Acks) or multi-user (MU) block acknowledgements (BA) that preempts the empty frequency or time slot to monitor the frames from its associated AP MLD to determine if it should stop transmission within the ongoing R-TWT SP;
(ii) allowing the roaming non-AP MLD to send a frame to its associated AP MLD to indicate it no longer needs to be served by the ongoing R-TWT SP; wherein the AP MLD receives this frame that is addressed to it, and terminates the current R-TWT SP, unless there are other R-TWT members of this R-TWT SP using this R-TWT SP, in which case the AP MLD maintains the R-TWT SP for other R-TWT members and suspends the R-TWT membership of the roaming non-AP MLD; and
(b) requiring, in the case of a roaming non-AP MLD associated with several serving AP MLD, the roaming non-AP MLD to have at least one link to maintain the association with the original AP MLD and the original R-TWT schedule on that link, or links, while on the remaining link, or links, the roaming non-AP MLD follows the same rule as in step (a).

8. The apparatus of claim 1, wherein the apparatus provides new enhanced R-TWT resume or restart rules for when the roaming non-AP MLD finishes its transition to the BSS of the roaming target AP MLD, and performs steps comprising:
(a) performing steps in the case of a roaming non-AP MLD associated with a single serving AP MLD, comprising:
(i) resuming or restarting the R-TWT SP based on the predetermined enhanced R-TWT schedule without requiring further negotiation, when there is no ongoing R-TWT SP in the new BSS, the AP MLD of the new BSS and/or the roaming non-AP MLD; and wherein in case of an enhanced R-TWT SP scheduled for the roaming non-AP MLD in the target BSS which hasn't yet started, the AP MLD of the new BSS applies UL orthogonal frequency domain multiple access (OFDMA)-based random access (UORA) to trigger the roaming non-AP MLD to provide random access;
(ii) granting the roaming non-AP MLD a temporary membership of the ongoing R-TWT SP, by the target AP, when there is an existing ongoing R-TWT SP in the new BSS, which is not the same as the predetermined R-TWT SP for the roaming non-AP MLD;
(iii) triggering the roaming non-AP MLD, by the target AP MLD, as the member and the roaming non-AP MLD should access the medium during the R-TWT SP with the R-TWT member priority, when there is an existing ongoing R-TWT SP in the new BSS, which is the same as the predetermined R-TWT SP for the roaming non-AP MLD;
(b) assuring that the roaming non-AP MLD has at least one link to maintain the association with the original AP MLD and the original R-TWT schedule on that link, when a roaming non-AP MLD is associated with several serving AP MLDs;
while on the remaining link, or links, the roaming non-AP MLD should follow step (a).

9. The apparatus of claim 8, wherein the roaming STA affiliated with a roaming non-AP MLD determines or identifies if it has moved close to the edge of the associated AP MLD based on criteria selected from the group of selection criterion, consisting of:
(a) throughput and/or packet loss rate of its transmission;
(b) received signal strength indicator (RSSI) of the received acknowledgement or multiple-user (MU) block acknowledgement (BA) as the response of its transmitted multi-user (MU) physical-layer protocol data unit (PPDU);
(c) RSSI of the received preemption acknowledgement or multiple-user (MU) block acknowledgement (BA) as the response of its transmitted (MU) PPDU with empty frequency or time slot(s) for preemption;
(d) detection of OBSS signals, in terms of the RSSI of the overlapping BSS (OBSS) signal, and the frequency of the detection of OBSS signals; and
(e) roaming signals from the co-located station which is affiliated with the same roaming non-AP MLD.

10. A multiple station apparatus for communication in a wireless network, the apparatus comprising:
(a) a multiple link device (MLD) having at least two stations, in which each station has at least one modem coupled to at least one radio-frequency (RF) circuit, with each RF circuit connected to one or multiple antennas;
(b) a processor of said MLD;
(c) a non-transitory memory storing instructions executable by the processor for wirelessly communicating with other stations on a IEEE 802.11 wireless local area network (WLAN); and
(d) wherein said instructions, when executed by the processor, perform steps of a wireless communications protocol, comprising:
(i) wherein said MLD operates a wireless communications protocol as either an access point (AP) MLD or a non-AP MLD;
(ii) wherein when said MLD is operating as a non-AP MLD, it is configured for transmitting and/or receiving latency sensitive traffic during a R-TWT SP in a first BSS;
(iii) wherein said MLD is configured to allow roaming from this first BSS of an original AP MLD to which it is associated, to a second BSS of a target AP MLD;
(iv) wherein the roaming non-AP MLD, or one or more station links within the roaming non-AP MLD, negotiates to use a predetermined and/or enhanced R-TWT SP of the target AP MLD, whereby after roaming the non-AP MLD, or one or more station links within the roaming non-AP MLD, can immediately communicate in the R-TWT SP of the target AP MLD without further negotiation;
(v) wherein when said MLD is operating as an AP MLD, it can contain MLD common functions in the MLD upper MAC sublayer and contain per-link functions in MLD lower MAC sublayer;
(vi) wherein when said MLD is operating as an AP MLD, it connects its lower MAC sublayer with the roaming AP MLD upper layer through a backhaul connection with a roaming AP MLD, which functions as a central controller; wherein the TID-to-Link mapping and the link merging functions are carried in the MLD common functions in the AP MLD upper MAC or in the roaming AP MLD upper MAC; and
(vii) wherein the roaming non-AP MLD can set up an enhanced R-TWT SP at a roaming AP MLD level or at an AP MLD link level, either of which are to be completed before roaming is finished. and wherein in scheduling an enhanced R-TWT SP for roaming at the AP MLD level, then either a universal enhanced R-TWT SP, or non-universal enhanced R-TWT SP with multiple R-TWT SPs corresponding to different AP MLD of the roaming AP MLD, can be scheduled.

11. The apparatus of claim 10, wherein when a roaming non-AP MLD, which is in process of transmitting or receiving latency sensitive traffic during a R-TWT SP, is roaming from the BSS of its original associated AP MLD to the BSS of its target AP MLD, it can use a predetermined or enhanced R-TWT SP accepted by the target AP MLD, without further negotiation for an R-TWT SP after roaming.

12. The apparatus of claim 10, wherein in scheduling an enhanced R-TWT SP at the AP MLD level, the non-AP MLD can negotiate an enhanced R-TWT with the target AP MLD, through relaying of its associated AP MLD and the roaming AP MLD, comprising:
(a) allowing the current associated AP MLD to negotiate an enhanced R-TWT schedule with the non-AP MLD on behalf of the target AP MLD before roaming; or
(b) allowing the current associated AP MLD to negotiate an enhanced R-TWT schedule with the non-AP MLD on behalf of the target AP MLD along with the exchange of fast BSS transition (FT) request and FT response frames during roaming; or
(c) allowing the non-AP MLD to directly negotiate the enhanced R-TWT schedule with the target AP MLD through the exchange of (re)association request and (re)association response frames that carry the enhanced R-TWT element at the end of roaming.

13. The apparatus of claim 10, wherein in achieving an enhanced R-TWT SP setup, a new TID-to-Global-Link mapping is configured to indicate the links, identified by global link identifiers, on which frames belonging to each traffic identifier (TID) can be exchanged by any of the following, comprising:
(a) supporting the TID-to-Global-Link Mapping (TTGLM) negotiation, which can be processed during multilink (ML) setup or re-setup by the Roaming non-AP MLD, or by the roaming AP MLD and the affiliated AP MLDs of the roaming AP MLD; or
(b) utilizing a new TTGLM element which is configured to indicate the links, which are identified by global link identifiers (IDs), on which frames belonging to each traffic identifier (TID) can be exchanged; or
(c) negotiating the TTGLM, by the roaming non-AP MLD, with the roaming AP MLD through the relay of its associated AP MLD; or
(d) performing TTGLM negotiation of the TID-to-Global-Link Mapping with an exchange of TID-To-Global-Link Mapping Request frame and TID-To-Global-Link Mapping Response frame that carries the TID-to-Global-Link Mapping element; or
(e) performing TTGLM negotiation by exchanging an association request frame, or reassociation request frame, and association response frames or reassociation response frames that carry the TID-to-Global-Link Mapping element.

14. The apparatus of claim 10, wherein the apparatus provides new enhanced R-TWT termination rules when the roaming non-AP MLD is moving close to, or across, the edge of the original associated AP MLD, and performs steps comprising:
(a) performing steps, in the case of roaming a non-AP MLD associated with a single serving AP MLD, comprising:
(i) requiring the roaming non-AP MLD to have at least one link for exchanging multiple user (MU) physical-layer protocol data units (PPDUs) with an empty frequency or time slot and using acknowledgements (Acks) or multiple user (MU) block acknowledgements (BA) that preempts the empty frequency or time slot to monitor the frames from its associated AP MLD to determine if it should stop transmission within the ongoing R-TWT SP;
(ii) allowing the roaming non-AP MLD to send a frame to its associated AP MLD to indicate it no longer needs to be served by the ongoing R-TWT SP; wherein the AP MLD receives this frame that is addressed to it, and terminates the current R-TWT SP, unless there are other R-TWT members of this R-TWT SP using this R-TWT SP, in which case the AP MLD maintains the R-TWT SP for other R-TWT members and suspends the R-TWT membership of the roaming non-AP MLD; and
(b) requiring, in the case of a roaming non-AP MLD associated with several serving AP MLD, the roaming non-AP MLD to have at least one link to maintain the association with the original AP MLD and the original R-TWT schedule on that link(s), while on the remaining link, or links, the roaming non-AP MLD follows the same rule as in (a).

15. The apparatus of claim 10, wherein the apparatus provides new enhanced R-TWT resume or restart rules for when the roaming non-AP MLD finishes its transition to the BSS of the roaming target AP MLD, and performs steps comprising:
(a) performing steps in the case of a roaming non-AP MLD associated with a single serving AP MLD, comprising:
(i) resuming or restarting the R-TWT SP based on the predetermined enhanced R-TWT schedule without requiring further negotiation, when there is no ongoing R-TWT SP in the new BSS, the AP MLD of the new BSS and/or the roaming non-AP MLD; and wherein in case of an enhanced R-TWT SP scheduled for the roaming non-AP MLD in the target BSS which hasn't yet started, the AP MLD of the new BSS applies UL orthogonal frequency domain multiple access (OFDMA)-based random access (UORA) to trigger the roaming non-AP MLD to provide random access;
(ii) granting the roaming non-AP MLD a temporary membership of the ongoing R-TWT SP, by the target AP, when there is an existing ongoing R-TWT SP in the new BSS, which is not the same as the predetermined R-TWT SP for the roaming non-AP MLD;
(iii) triggering the roaming non-AP MLD, by the target AP MLD, as the member and the roaming non-AP MLD should access the medium during the R-TWT SP with the R-TWT member priority, when there is an existing ongoing R-TWT SP in the new BSS, which is the same as the predetermined R-TWT SP for the roaming non-AP MLD;
(b) assuring that the roaming non-AP MLD has at least one link to maintain the association with the original AP MLD and the original R-TWT schedule on that link, when a roaming non-AP MLD is associated with several serving AP MLDs; while on the remaining link, or links, the roaming non-AP MLD should follow (a).

16. The apparatus of claim 15, wherein the roaming STA affiliated with a roaming non-AP MLD determines or identifies if it has moved close to the edge of the associated AP MLD based on criteria selected from the group of selection criterion, consisting of:
(a) throughput and/or packet loss rate of its transmission;
(b) received signal strength indicator (RSSI) of the received acknowledgement or multiple-user (MU) block acknowledgement (BA) as the response of its transmitted multi-user (MU) physical-layer protocol data unit (PPDU);
(c) RSSI of the received preemption acknowledgement or multiple-user (MU) block acknowledgement (BA) as the response of its transmitted (MU) PPDU with empty frequency or time slot(s) for preemption;
(d) detection of OBSS signals, in terms of the RSSI of the overlapping BSS (OBSS) signal, and the frequency of the detection of OBSS signals; and
(e) roaming signals from the co-located station which is affiliated with the same roaming non-AP MLD.

17. A method of communicating in a wireless network with a multiple link device, the comprising:
(a) communicating in a wireless network in which at least one multiple link device (MLD) with at least two stations with each station having at least one modem coupled to at least one radio-frequency (RF) circuit, with each RF circuit connected to one or multiple antennas;
(b) operating said MLD in a wireless communications protocol as either an access point (AP) MLD or a non-AP MLD;
(c) wherein when said MLD is operating as a non-AP MLD, it is configured for transmitting and/or receiving latency sensitive traffic during a R-TWT SP in a first basic service set (BSS);
(d) wherein said MLD is configured to allow roaming from this first BSS of an original AP MLD to which it is associated, to a second BSS of a target AP MLD;
(e) wherein the roaming non-AP MLD, or one or more station links within the roaming non-AP MLD, negotiates to use a predetermined and/or enhanced R-TWT SP of the target AP MLD, whereby after roaming the non-AP MLD, or one or more station links within the roaming non-AP MLD, can immediately communicate in the R-TWT SP of the target AP MLD without further negotiation;
(f) wherein when said MLD is operating as an AP MLD, it can contain MLD common functions in the MLD upper MAC sublayer and contain per-link functions in MLD lower MAC sublayer; and
(g) wherein when said MLD is operating as an AP MLD, it connects its lower MAC sublayer with the roaming AP MLD upper layer through a backhaul connection with a roaming AP MLD, which is a function as a central controller; wherein the TID-to-Link mapping and the link merging functions are carried in the MLD common functions in the AP MLD upper MAC or in the roaming AP MLD upper MAC.
